(19) United States
(12) Patent Application Publication
(10) Pub. No.: US 2006/0272483 A1
(43) Pub. Date: Dec. 7, 2006

(54) Player piano system interface

(76) Inventor: David R. Honeywell, Lincoln, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/410,539

(22) Filed: Apr. 24, 2006

Related U.S. Application Data
(63) Continuation-in-part of application No. 10/407,869, filed on Apr. 3, 2003, now abandoned.
(60) Provisional application No. 60/370,469, filed on Apr. 4, 2002.

(51) Int. Cl. G10H 7/00; A63H 5/00; G04B 13/00

(52) U.S. Cl. 84/609

(57) ABSTRACT

A player piano system including a player piano having a core computing device with programming, a storage device installed therein configured to communicate with at least one second computing device such as an Internet server. A remote controller device communicates with the core computing device and provides remote access to the player piano controls.

### CROSS-REFERENCE TO RELATED APPLICATIONS

This application is a continuation-in-part of copending application Ser. No. 10/407,869 filed on Apr. 3, 2003, which claims priority from U.S. provisional application Ser. No. 60/370,469, filed on Apr. 4, 2002, both of which are incorporated herein by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to player pianos, and more particularly to computer controlled player pianos and accompaniment with a remote access interface.

2. Description of Related Art

Mechanism operated pianos, also known as player pianos, first appeared in the late nineteenth century. Player pianos became a popular source of entertainment in the home as well as in the theater. Silent movies were often displayed with music provided by a player piano. One early type of player piano included a self-playing mechanism, normally pneumatic, capable of playing music controlled by a perforated paper music roll. Other player pianos included a cabinet that contained a pneumatic mechanism that was pushed in front of an ordinary piano. A row of felt-covered wooden fingers rested on the piano keys. Inside the cabinet a music roll passed over a tracker bar with eighty-eight slots, one for each note, and a mechanism that actuated the mechanical fingers in appropriate succession. When a perforation in the moving roll uncovered a slot in the bar, suction from a bellows could draw the air through the port and trigger the mechanism that would force the wooden finger down. The vacuum created by the apparatus was typically generated by foot treadles mechanically coupled to the bellows.

Later player piano designs incorporated the playing mechanism into the piano. Other improvements included electric vacuum motors that eliminated the need of the player to push pedals to mechanically activate the bellows.

Early player piano rolls were made by hand-punching holes in a roll to correspond to published sheet music and the characteristics of a particular performance or a performer were not involved. By 1912, however, player piano devices were developed that allowed the roll to be marked or perforated as the pianist performed. This revolutionized the medium because it gave a fairly accurate representation of the player's style and performance. For a period, player pianos became so popular that it was not unusual for a student to learn the piano by following the movement of the keys of a player piano.

In the 1970's, the player piano roll was replaced by data recorded on a cassette tape and a control device that drove solenoids under the piano keys. This offered a new medium for player piano performances that was consistent and the tapes were durable and easily transported and stored.

Modern player pianos have become gradually more computerized and are capable of playing any performance played on them note-for-note as well as generally reflecting the nuances of interpretation. Some modern player pianos are capable of recording a performance by the user. To accomplish this task, these player pianos are fitted with a computer and sensors that record a hand-played performance on a medium such as a floppy disk. On playback from the disk, the piano's keys move up and down like a classic player piano recreating the original performance.

Another improvement in modern player pianos is the capability of the piano to play background music so that the user can play the piano accompanied by other instruments or voice. These systems also provide a player piano performance accompanied by digital music for a performance that is generated electronically and mechanically.

However, present player piano systems that utilize computer controlled key actuation require access points on the piano for the insertion of tapes, disc's or CD's into drives creating unsightly opening in the structure of the piano or mounting points.

Present player pianos also have the limitation of the dependence on disc or tape media drives is the requirement of repetitive changing of discs or tapes to allow successive performances from multiple performers.

Another limitation of current systems is their inability to be attached to or controlled by other multimedia devices such as televisions, monitors, personal computers and similar devices.

Accordingly, there is a need for a player piano system and interface that is concealed within the body of the piano, has remote access to player piano controls by one or more computing devices that are geographically remote from the piano, and a system that can become networked with other player piano systems as well as media sources. The present invention satisfies these needs, as well as others, and is generally an improvement in the art.

### BRIEF SUMMARY OF THE INVENTION

A player piano system interface according to the invention includes a standard player piano that is capable of causing the hammers to strike the strings or actuate piano keys with proper timing and strike strength in response to a signal from a control unit as well as cause pedal activation and other piano functions.

An operations center or control unit is provided that preferably includes a microprocessor. The control unit is operably coupled with the hammer striking apparatus and other common player piano functions. The control unit is preferably mounted within the piano so that it is not visible from the exterior of the piano. The preferred control unit has a microprocessor and a storage device. The storage device is preferably a hard disk drive but may also be a floppy disk drive, or a CD/DVD drive or similar magnetic or optical storage devices. The operations center may operate as a server that can be accessed through local area network connections or through the Internet.

A remote device provides access to the control unit and the player piano controls. The control unit may be directly connected with the remote device through wired plug and socket connections such as Ethernet, coaxial, multi-pin, or USB ports and the like. For example, the remote device may be a television, a monitor, a personal computer, a flash media card, or an Internet appliance. These devices may also include DVD, CD or floppy disc drives to provide an additional source of access to software or other media.

The remote device can also be wireless using radio frequency or infrared ports or similar systems. For example the remote device could be a portable data assistant, a handheld remote, a web slate, a cellular phone or a laptop or desktop computer. The piano may have wired or wireless connections alone or in combination to provide access to the performance controls of the player piano as well as access to control files, background music or other recordings.

In a preferred embodiment, the remote device includes a touch screen interface that provides access to the player piano controls. Preferably, the touch screen interface includes a main interface that provides remote access to song playlists stored within the player piano, e.g., in the storage device. The touch screen interface also includes an audio interface that provides remote access to audio controls within the player piano. Additionally, the touch screen interface includes a program interface that provides remote access to a program function within the player piano.

Preferably, the touch screen interface further includes a performance interface that provides remote access to performance controls within the player piano. Moreover, the touch screen interface can include a backstage interface that provides remote access to adjustable settings within the player piano. Also, the touch screen interface can include a record interface that provides remote access to recording functions within the player piano. In a preferred embodiment, the touch screen interface also includes a help interface that provides remote access to a help screen.

It can be seen that the system of the invention permits geographically remote control over the piano functions of a player piano. Such control allows, for example, the performance on one piano to be simultaneously performed on a second piano. Therefore, a piano teacher in one part of the country can give piano lessons to a student in another part of the country or the world. Similarly, a piano performance can be televised or broadcast in another media with the player piano faithfully recreating the performance on thousands of remote pianos in real time. Thus, the music is provided by the instrument rather than being translated through a microphone and speakers.

Control over the player piano functions including recorded background music can also be provided with remote auxiliary devices or from a central server connected over the Internet or closed connection network to the piano interface.

An aspect of the invention is to provide a player piano with access by a remote interface.

Another aspect of the invention is to provide a remote interface for a player piano with touch screen access.

A still further aspect of the invention is to provide a remote interface for a player piano that provides remote access to control functions associated with the player piano.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWINGS

The invention will be more fully understood by reference to the following drawings which are for illustrative purposes only:

FIG. 1 is a perspective view of a schematic of a player piano with an embodiment of a player piano system with a software interface according to the present invention.

FIG. 2 is a block diagram of one embodiment of a player piano system with a software interface according to the invention.

FIG. 3 is an example of a main interface screen of the software interface system according to the invention.

FIG. 4 is an example of a hard disk drive control screen accessible via the main interface of FIG. 3.

FIG. 5 is an example of a compact disk drive control screen accessible via the main interface.

FIG. 6 is an example of a floppy disk drive control screen accessible via the main interface.

FIG. 7 is an example of an Internet control screen accessible via the main interface.

FIG. 8 is an example of a master volume control screen accessible via the audio interface that is accessible from the main interface.

FIG. 9 is an example of a piano volume control screen accessible via the audio interface.

FIG. 10 is an example of a symphony volume control screen accessible via the audio interface.

FIG. 11 is an example of a digital volume control screen accessible via the audio interface.

FIG. 12 is an example of an auxiliary volume control screen accessible via the audio interface.

FIG. 13 is an example of a microphone volume control screen accessible via the audio interface.

FIG. 14 is an example of a play mode screen accessible through the program interface that is accessible via the main interface.

FIG. 15 is an example of a play mode screen showing the shuffle icon accessible through the program interface.

FIG. 16 is an example of a play mode screen showing the cue icon accessible through the program interface.

FIG. 17 is an example of a repeat mode screen accessible via the program interface showing the repeat icon.

FIG. 18 is an example of a schedule screen accessible via the program interface.

FIG. 19 is an example of a create playlist screen accessible via the program interface.

FIG. 20 is an example of a copy screen accessible via the program interface.

FIG. 21 is an example of a file management screen accessible via the program interface.

FIG. 22 is an example of a tempo change screen accessible through the performance interface.

FIG. 23 is an example of a transpose screen accessible via the performance interface.

FIG. 24 is a view of the synchronization screen accessible via the performance interface.

FIG. 25 is an example of an instrument screen accessible via the performance interface.

FIG. 26 is an example of a channel masking screen accessible via the performance interface.

FIG. 27 is an example of a key masking screen accessible via the performance interface.

FIG. 28 is an example of a metronome screen accessible via the performance interface.

FIG. 29 is a view of the first preferences screen accessible via the backstage interface.

FIG. 30 is a view of the second preferences screen accessible via the backstage interface.

FIG. 31 is an example of the third preferences screen accessible via the backstage interface.

FIG. 32 is an example of a record settings screen accessible via the backstage interface.

FIG. 33 is an example of the first network screen accessible via the backstage interface.

FIG. 34 is a view of the second network screen accessible via the backstage interface.

FIG. 35 is a view of the third network screen accessible via the backstage interface.

FIG. 36 is an example of an audio screen accessible via the backstage interface.

FIG. 37 is an example of a send screen accessible via the backstage interface.

FIG. 38 is a view of the first silent drive screen accessible via the backstage interface.

FIG. 39 is a view of the second silent drive screen accessible via the backstage interface.

FIG. 40 is a view of the third silent drive screen accessible via the backstage interface.

FIG. 41 is an example of a fourth silent drive screen accessible via the backstage interface.

FIG. 42 is a view of the fifth silent drive screen accessible via the backstage interface.

FIG. 43 is a view of the record interface screen.

FIG. 44 is a view of the help interface accessible via any of the available storage device interfaces.

FIG. 45 is a view of the main interface help screen accessible via the help interface.

FIG. 46 is a view of the audio interface help screen accessible via the help interface.

FIG. 47 is a view of the program interface help screen accessible via the help interface.

FIG. 48 is a view of the performance interface help screen accessible via the help interface.

FIG. 49 is a view of the backstage interface help screen accessible via the help interface.

FIG. 50 is an example of a frequently asked questions screen accessible via the help interface.

### DETAILED DESCRIPTION OF THE INVENTION

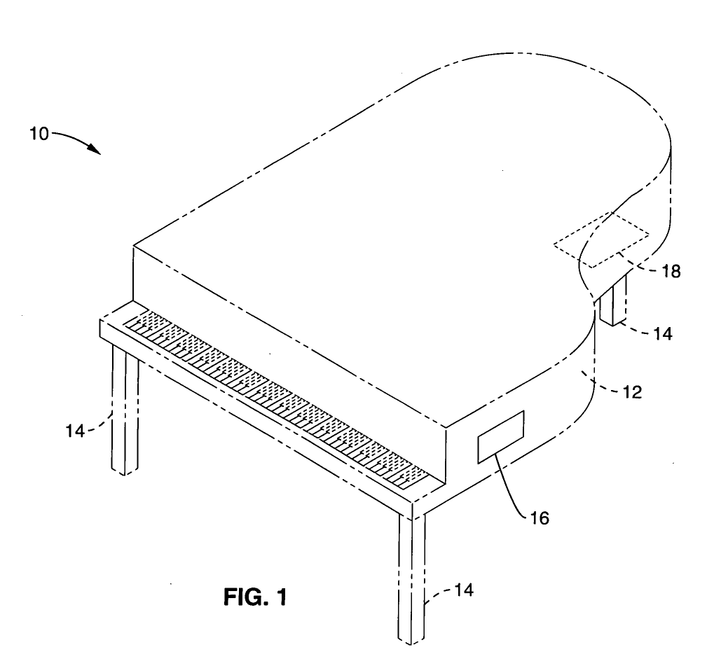

Referring more specifically to the drawings, for illustrative purposes the present invention is embodied in the apparatus generally shown in FIG. 1 through FIG. 50. It will be appreciated that the apparatus and systems may vary as to configuration and as to details of the parts, and that the method may vary as to the specific steps and sequence, without departing from the basic concepts as disclosed herein.

Turning now to FIG. 1, one embodiment of a player piano with an interface system 10 according to the invention is generally shown. A player piano system interface 10 according to the invention is adapted to a standard player piano that is capable of causing the hammers to strike the strings or actuate the keys in response to a signal from a control unit as well as cause pedal activation and other functions. In this embodiment, the piano can also be played manually or may be played accompanied with music obtained from a variety of sources as described herein. Piano performances may also be recorded.

A traditional grand piano in the embodiment shown in FIG. 1 has a body with a sound box 12 supported by legs 14. While a grand piano is shown as an illustration, it will be understood that any type of player piano can be used in conjunction with the control system of the present invention. The body of the piano 10 has the core control system 18 installed within or below the sound box. The control unit 18 is preferably mounted within the piano so that it is not visible from the exterior of the piano.

The body of the piano 12 may also have a media access panel 16 to allow access to drive mechanisms configured to removable media such as floppy disks, compact discs, DVD's and other magnetic or optical drives that are operably connected to the core control unit 18. In another embodiment, the drive mechanisms of a remote computing device that is connected through wired or wireless connections to the control unit 18 are used to transfer files of different formats from removable media or other storage media or devices.

Access panel 16 may also be an access port with compatible sockets to attach additional components such as a telephone jack, USB port, microphone or headphone jacks, and other conventional couplings that will permit access to and from the control unit 18. Alternatively, and additionally, the control unit 18 may also have wireless or infrared couplings to other devices.

The control unit 18 is operably coupled with the hammer striking apparatus and other common player piano functions. In one embodiment, the control unit 18 of the piano includes a system for detecting and recording the characteristics of a manual performance of a user and thereafter reproducing the performance. Sequence, timing and strength of depression of the keystrokes along with pedal control or other performance characteristics may also be recorded, stored or transmitted to another instrument or system.

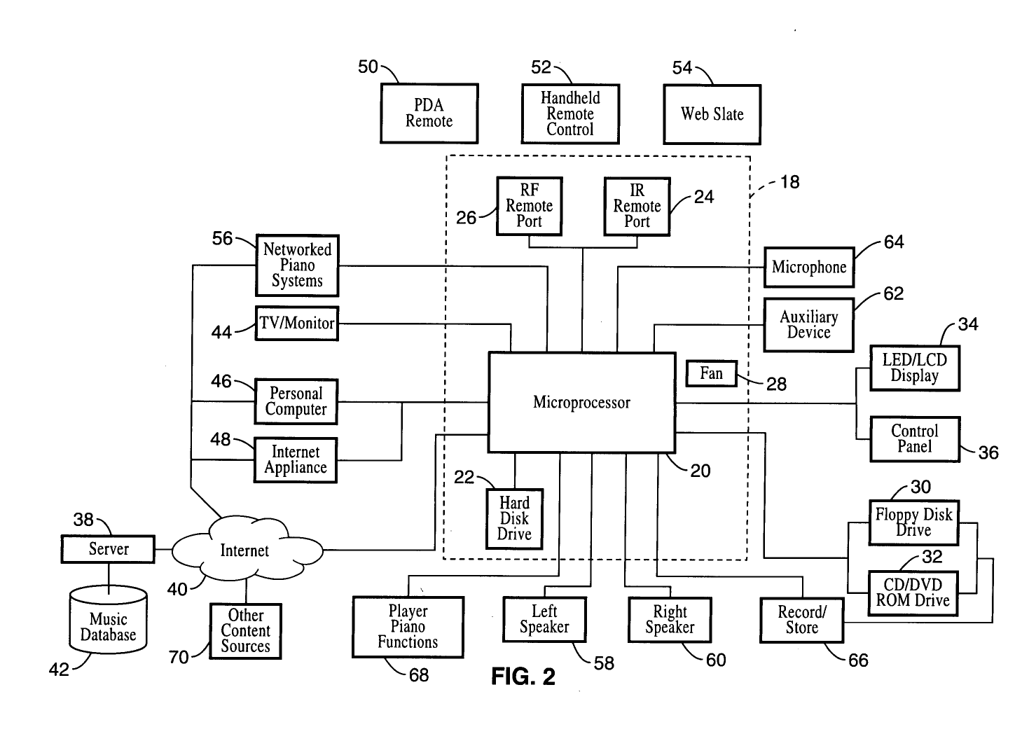

The core control system 18 is schematically shown in FIG. 2. The core system 18 provides access to and control of all of the input and output functions associated with a player piano as illustrated in the embodiment of FIG. 1. It can be seen that the control system has input and output functions that can be adapted to communicate with many different types of devices and have many different configurations. The control system 18 is also capable of communicating with remote devices and networks and controlling or being controlled by these devices through the Internet, cable, Ethernet, telephone line, wireless or other means for a functional connection. Accordingly, the embodiment shown schematically in FIG. 2 is not meant to be comprehensive of every possible function or attached input or output device.

At the center of the control system 18 is a computing function with suitable memory and at least one microprocessor 20 that is configured to be coupled to the desired input and output devices as shown in FIG. 2. In addition, an internal storage device such as a hard disk drive 22 can be connected to the computer and microprocessor 20 to provide software and data storage space for the system. In one embodiment, the hard disk drive 22 can be pre-loaded with interface software, music and performance files. In addition, new music and other files can be added via Internet downloads, networked computers and magnetic 30 or optical drives 32.

As shown, the core system 18 can also include wireless remote input/output ports 24, 26 and a fan 28 for keeping the system components installed in the piano 10 of FIG. 1 from over-heating. The wireless remote input ports 24, 26 can be the connection to the microprocessor 20 as well as command functions for data transfer from remote computing devices, communications connections or storage devices such as floppy disk or CD/DVD ROM drives.

In a preferred embodiment, the microprocessor 20 apparatus utilizes an operating system that is widely used, such as the Linux or Windows operating systems, to provide broad compatibility for the system. Moreover, it is to be understood that the system can manage and play multiple formats such as Type 0 and Type 1 Standard MIDI Files (SMF), Ogg Vorbis files and the like. The system has the flexibility to include a wide range of file formats so that music and data files from many different sources can be accommodated by the system.

It will be further understood that the control system 18 includes programming for providing different functionalities for the associated instrument as well as the operation or creation of files or the performance of music files and other functionalities. The programming of the present invention is preferably contained on the hard disk drive 22. In an alternative embodiment, some or all of the programming can be stored in a data storage device with a computer readable medium, such as a computer diskette, a magnetic tape, an optical storage device, an electronic read-only memory (ROM), flash memory or other appropriate data storage device or transmitting device thereby making a computer program product, i.e., an article of manufacture. In this embodiment, the apparatus may have a dedicated magnetic or optical disk drive with dedicated media or may have programming that is loaded at the start of a session. The programming may be written in essentially any programming language. In an illustrative embodiment of the invention, the computer-executable instructions may be HTML, JAVA or Macromedia Flash.

The core system 18 may also be connected with one or more input devices that are configured for the transfer of files to and from the core system 18 and the hard disk drive 22 in one embodiment. External input devices such as a floppy disk drive 30 and a CD/DVD ROM drive 32 can also be connected to the microprocessor 20 via a universal serial bus (USB) cable or other wired or wireless coupling. The external input devices may also be configured not only to introduce material to the core system 18, but also to receive material from the system 18 to be placed on magnetic or optical media on one embodiment. However, the drive components are not necessary to the function of the core system 18 and may be considered optional. Data files can be downloaded to the hard disk drive 22 from the floppy disk drive 30 and the CD/DVD drive 32. Data and music files can also be played directly from media used in the floppy disk drive 22 or the CD or DVD drive 32.

Another external data input device that may be connected to the core system 18 and the microprocessor 20 is an Internet connection 40. For example, the system 18 can be connected to a music server 38 via the Internet 40 in the embodiment shown in FIG. 2. The music server 38, in turn, can be connected to a music fileserver 42 giving the user access to files and music from a remote database. Accordingly, music can be downloaded to the microprocessor 20 from the fileserver 42 via the music server 38 and the Internet 40.

The core system 18 may also be connected to other content sources 70 via the Internet connection 40. Music, software updates, and other files can be transferred directly to the piano over the Internet from a central file or person-to-person from a second computer or piano system. In another embodiment, the core system 18 is connected to a source of streaming audio or video via the Internet or other communications scheme from a streaming media provider. In this embodiment, remote interactive piano instruction can be received from a provider as well as streaming audio or video performances.

A personal computer 46 or an Internet appliance 48 may also be connected to the system 18 through an input port to provide a source of data input and music files etc. from a remote location via the Internet or telephone lines. Alternatively, the personal computer 46 or an Internet appliance 48 can be connected to the microprocessor 20 via an Ethernet connection. It can be seen that many different network options can be provided and that the system is easily adaptable to new technology.

The core control system 18 also has a number of output functions. In the embodiment shown in FIG. 2, the control system 18 controls audio performance, recording, file storage and player piano performance output functions 68. The audio performance output control utilizes left speaker 58 and right speaker 60 to perform music and other audio files. Accordingly, the piano may be played by the user with the performance accompanied by complimentary or background music provided by the speakers 58, 60.

Speakers 58, 60 can also be used for the performance of recorded music, music that has been downloaded from a music database 42 over the Internet, music from the floppy disk drive 30 or the optical disk drive 32 or music stored on the hard drive 22. The audio performance of recorded music or player piano content may be conducted directly from optical or magnetic media in the drives 30, 32 or can be from recorded files on the hard drive 22. Audio files may be used to accompany the user of the piano or other instrument to provide a fuller performance capability than presently available with conventional pianos or player pianos.

Another output function of the core control system 18 is the record and storage function 66. In this embodiment, the user can record and store a performance file or music file in different formats. For example, an audio file can be made of a piano performance with a music file accompaniment that may be stored on the hard drive 22 or recorded on magnetic media on the floppy disk drive 30 or optical media on the CD/DVD drive 32. Likewise, player piano functions may be recorded on magnetic or optical media or stored on hard drive 22.

Player piano functions 68 are also controlled by the core control system 18. In one embodiment, the player piano functions 68 include controlling the force that the hammer strikes the strings, the timing and extent of depression of the piano pedals, the sequence and timing of the keystrokes etc. In this embodiment, the performance of a user can be duplicated by player piano re-creating the pedal and keystrokes of the performance. The performance can be recorded for future use in composing music or for subsequent performances.

In one embodiment, the performance recording of the player piano functions 68 can be transmitted via the Internet 40, telephone lines or other form of data transfer to a second player piano at a remote location in real time. The second piano will accurately recreate the performance on the first piano. The second piano may also be linked to the first piano in the same fashion effectively allowing remote control over pianos at different locations. This permits the possibility of remote piano lessons in different parts of the country with the teacher and student at different locations. This also provides the capability of the live performance on one piano to be simultaneously performed on any number of networked pianos through the creation of a network 56. Likewise, the recorded performance of a great artist, for example, can be obtained from a central source over a communications system such as the Internet and recreated on the piano of the user. The retrieved performance may also include a background musical or voice accompaniment. Similarly, a contemporary performance of a musician in real time that includes player piano commands may be transmitted along with a video feed of the performance to a user on a pay per view or subscription basis. In this embodiment, the performance can be viewed while the piano precisely executes the musical performance of the musician.

In another embodiment, the player piano functions 68 may be tied through the core system 18 to the input of an auxiliary device 62 such as an electric guitar or other instrument or audio file. The combined performance can be recorded on magnetic or optical media or on hard disk drive 22. In another embodiment, the input from the microphone 64 can be tied through the core system 18 with the player piano functions so that a user can sing or talk along with the piano performance.

The auxiliary device 62 may also be a video camera and monitor that will allow visual and audio communications with another similarly configured networked piano or to recording device along with player piano functions, for example. In this embodiment, a piano teacher in one location can view and communicate with a student in another location.

Control of the core system 18 and the associated input and output devices is preferably facilitated by a display interface. The display interface may be part of the piano or may be part of an input device associated with the core system 18. In one preferred embodiment, the display interface uses touch screen technology to easily navigate the programming.

In another embodiment, the piano 10 has a control panel 36 with a display that is accessible from the access panel 16 shown in FIG. 1. In this embodiment, the control panel 36 and the display are hard wired with the core system 18. In another embodiment, the display is an LED/LCD display 34 that can be optionally connected to the core system 18 and microprocessor 20. The LED/LCD display 34 can be as simple as a small three-digit numeric display that can be used to indicate the current song number being played by the piano 10 (FIG. 1). In another embodiment, the LED/LCD display 34 may also indicate playback, record, power and the status of other functions.

The control panel 36 can also be connected to the core system 18 and microprocessor 20 with control buttons. The control panel 36 may also be a keyboard. In a preferred embodiment, the control panel 36 can include simple controls such as play, pause, stop, eject, record, scan, and power. The control panel 36 can allow a user to operate the piano 10 (FIG. 1) like a standard tape or CD player by depressing a play button. Advanced functionality can require the use of a secondary user interface, described below. It is to be understood that the floppy disk drive 30, the CD/DVD drive 32, the LED/LCD display 34 and the control panel 36 can be incorporated into the media access panel 16 (FIG. 1) described above.

The display interface may also be part of a remote laptop or personal computer 46 or of the Internet appliance 48 that is connected to the system 18 via wire lines and the Internet for example. The embodiment shown in FIG. 2 also includes a TV/Monitor 44 that can be connected to the system 18 and microprocessor 20 by a video cable or other suitable connection. A user can access the advanced functionality of the system 18, via the TV/Monitor 44 using touch screen technology or another input device such as a small, tethered ½ VGA remote.

As shown in FIG. 2, a bi-directional infrared remote (IR) port 24 and a bi-directional radio frequency (RF) port 26 can be incorporated into the core system 18 and connected to the microprocessor 20 to provide wireless access to the system for command or data transfer functions. Either the IR port 24 and/or the RF port 26 can be used to allow access to the features via a standard remote control or a remote device with an interface configured to control the input and output functions of the core system 18. Since the data flow through each port 24, 26 can be bi-directional, a remote communicating with either port 24, 26 can include status indicators as well as more advanced functionalities.

Remote interface devices can take many forms ranging from devices with dedicated function buttons to wireless touch screen computing devices. For example, in the embodiment shown in FIG. 2, a personal data assistant (PDA) 50, a handheld remote control device 52, and a Web slate 54 are shown. It is to be understood that the handheld remote control device 52, the PDA 50 or the Web Slate 54 can be configured to access the core control system 18 through either the RF remote port 26 or the IR remote port 24 in this embodiment. In one embodiment, the web slate 54 is web-enabled and can also be used to access the advanced functionality of the core system 18 via a wireless Ethernet connection. Likewise, personal or laptop computers 46, cellular phones or other Internet devices 48 may communicate with and control the advanced functionality of the core control system 18 through wireless communications or through directly wired connections.

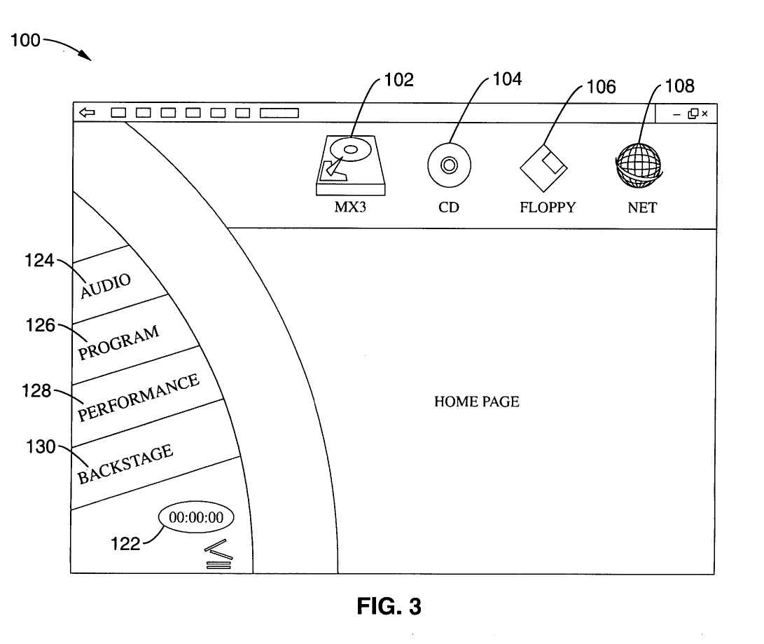

Programming of the apparatus shown schematically in FIG. 2, preferably provides a number of interactive screens permitting control over the different functionalities of the system. It will be seen that the programming illustrated in FIG. 3 through FIG. 49 can be easily adapted to many different hardware configurations and communications, storage and performance functions. Interface programming may be simple, controlled by a handheld remote control with dedicated buttons or even a cellular phone with a core system with a limited range of functions. Alternatively, the piano and core system 18 may be remotely controlled by more complex computing devices and communications and data storage capabilities.

For example, the functionality of the system 18 may be manifested in seven main interfaces that can be utilized by a user to optimize the performance of his or her player piano described above. In a preferred, non-limiting embodiment, these interfaces, include: a main interface, an audio interface, a program interface, a performance interface, a backstage interface, a record interface, and a help interface. Although, these interfaces representing the described functionalities are preferred, it will be understood that the player piano interface of the invention can have fewer functions and therefore fewer interfaces than indicated above. For example, the recording capabilities of the apparatus can be removed so that the system is capable of only reading media.

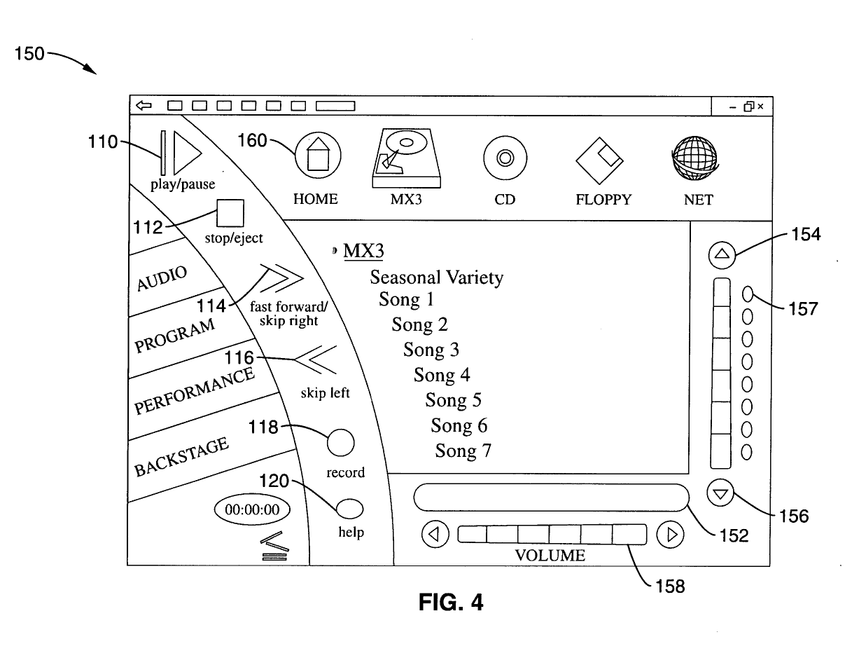

Referring now to FIG. 3, one embodiment of a main interface is shown and is designated generally as 100 illustrates the preferred functionalities of the interface and core system 18. FIG. 3 shows that the main interface 100 includes an “MX3” icon or button 102, a “CD” button 104, a “FLOPPY” button 106, and a “NET” button 108. These buttons can be toggled to choose a source for a song list, for example. Specifically, that the “MX3” button 102 can be toggled to access the hard disk drive control screen shown in FIG. 4. The “CD” button 104 can be toggled to access the CD drive control screen, described below. The “FLOPPY” button 106 can be toggled to access the floppy disk drive control screen, described below. And the “NET” button 108 can be toggled to access the Internet control screen, also described below.

As shown in FIG. 3, an elapsed time meter 122 can be provided to display the elapsed time of the song being played by the piano 10 (FIG. 1). FIG. 3 further shows an “AUDIO” button 124, a “PROGRAM” button 126, a “PERFORMANCE” button 128, and a “BACKSTAGE” button 130. Each of these buttons 124, 126, 128, and 130 can be toggled to open corresponding interfaces, i.e., an audio interface, a program interface, a performance interface, and a backstage interface, described below.

Referring also to FIG. 4, the hard disk drive control screen is shown and is designated 150. As shown, the hard disk drive control screen 150 includes the buttons described in conjunction with the main interface 100. In addition, a “play/pause” button 110 is provided and can be toggled to play or pause the piano 10 (FIG. 1). A “stop/eject” button 112 is provided and can be used to stop play and/or eject a CD. A “fast forward/skip right” button 114 is provided and can be used to fast forward through a song or skip to the next song. A “skip left” button 116 is also provided and can be used to skip back to the beginning of a song. A “record” button 118 is provided and can be used to begin recording. Moreover, a “help” button 120 is provided and can be used to open the help interface, describe in detail below. In addition, the hard disk drive control screen 150 includes a song list 152 that represents the songs available on the hard disk drive 22 (FIG. 1). FIG. 4 shows an “up” button 154 and a “down” button 156 that can be used to scroll through the song list 152. Furthermore, alphabetical “letter” buttons 157 are provided and can be used to quickly skip to songs within the song list 152 that begin with that letter. Moreover, a “volume” control button 158 is provided and can be used to control the volume of the piano 10 (FIG. 1) as well as any accompanying music. As shown in FIG. 4, the hard disk drive control screen 150 can also include a “HOME” button 160 that can be toggled to return to the main interface 100 (FIG. 3).

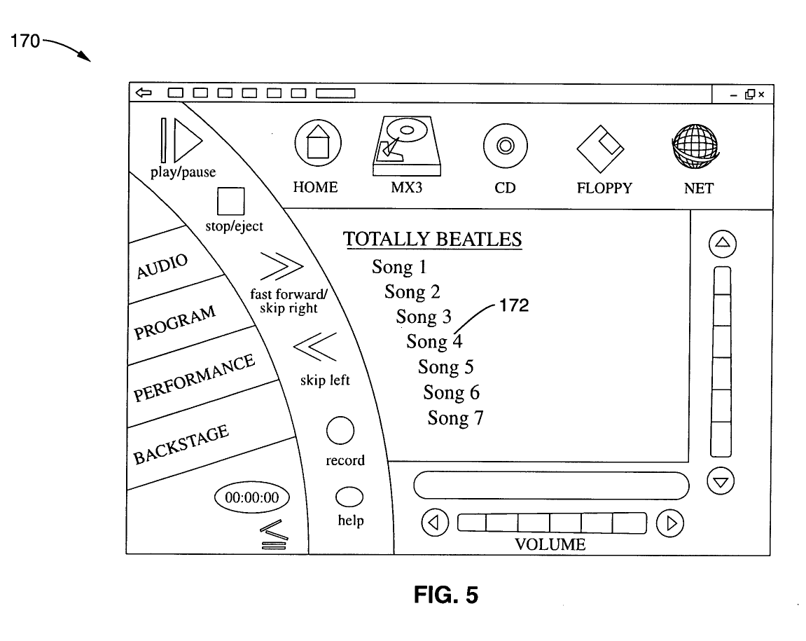

FIG. 5 shows the compact disc screen, designated 170, that can be accessed via the main interface 100 shown in FIG. 3. The CD drive control screen 170 includes a song list 172 that represents the songs available on the CD drive 32 (FIG. 1). In addition to the song list 172, the compact disc control screen includes the buttons provided by the main interface 100 (FIG. 3) and the control buttons provided by the hard disk drive control screen 150 (FIG. 4).

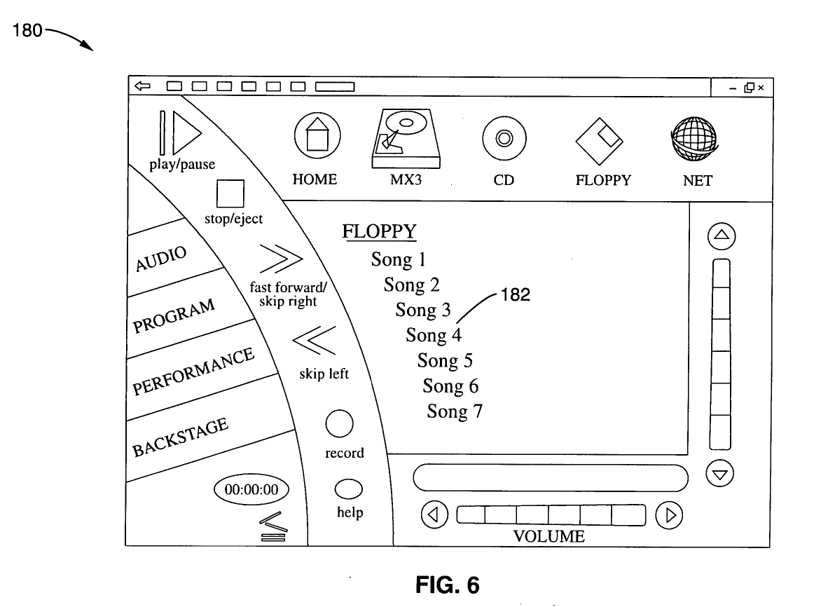

Referring now to FIG. 6, the floppy disk drive control screen is shown and is designated 180. It is to be understood that the floppy disk drive control screen can be accessed via the main interface 100 (FIG. 3) in this embodiment. As shown, the floppy disk drive control screen 180 includes the same buttons as the hard disk drive control screen 150 (FIG. 4) and the compact disc drive control screen 170 (FIG. 5). Moreover, the floppy disk drive control screen 180 includes a song list 182 that represents the songs available on the floppy disk drive 30 (FIG. 2).

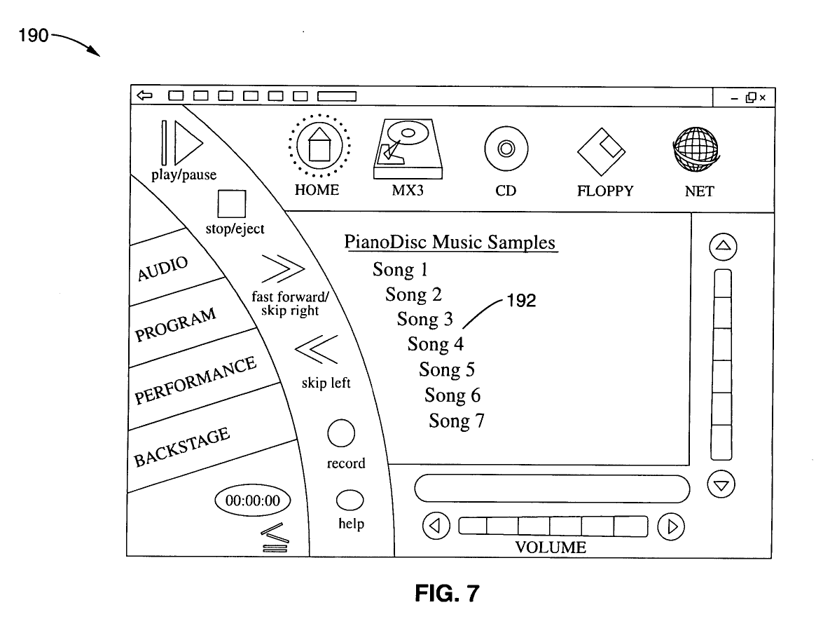

FIG. 7 shows the Internet control screen designated 190, that is available by toggling the “NET” button 108 at the main interface 100 (FIG. 3). As shown, the Internet control screen 190 includes the same buttons described in conjunction with the previous control screen. Additionally, the Internet control screen 190 includes a song list 192 that represents the songs available on the Internet, e.g., at the server 38 and music file server 42 (FIG. 2).

In the embodiment shown, a playlist contains one or more sections. Each section consists of a command with an optional count, media addition and/or media removal enclosed in braces, and a repeat value. At the beginning of each section, the microprocessor 20 (FIG. 2) generates an internal list of all included songs. During playback, the microprocessor 20 (FIG. 2) tracks the order in which songs are played. Among other uses, the playback history is used to prevent duplicate playback of the same song in shuffle mode. A song will only be repeated within a section when all other songs have been played, or when a section is repeated. Playback history is eliminated, and the next section starts from scratch, when a section is completed.

A playlist may contain any number of sections. When one section is finished, playback moves to the next section, and so on, until all sections have been played. It is also possible to write a section that repeats indefinitely. By combining commands, media, and repeat values, nearly any playback scenario can be realized. Each command may be followed by a count. The count specifies the number of songs to play. After the specified number of songs have been played, the section playback is complete unless a repeat value is selected. If the count is not specified, all included songs are played.

Depending on the operator, the media line adds media to or removes media from the list of songs to be played. The entire media section is always enclosed in braces. Each media line begins with a media type. For example, media from a floppy disk, a compact disk (CD), the Internet and Memory Expansion (MX) media are supported in the illustrated embodiment.

Media types can be listed stand alone to indicate inclusion or exclusion of all songs in the specified media type. The media type may also be followed by a library to indicate the addition or removal of all songs in a library. Lastly, the library or media type may be followed by a song's file name to indicate addition or removal of a single song. By specifying media, libraries, and songs the playback scope can be as wide or narrow as desired. By combing media lines with various scopes, it is easy to specify exactly what to play.

Within a section, any number of media inclusion or exclusion lines may be listed. The media section may consist simply of the addition of a media type, or it may specify individual songs in a specific order.

A repeat suffix may also be used in the playback section that is a numeric value that specifies the number of times the playback section should be repeated. There are two special cases for the repeat variable. First, if no repeat is specified, the section is simply played one time (equivalent to a repeat value of one). If the repeat value is set to zero (‘0’), the section can be repeated indefinitely (until the user stops playback).

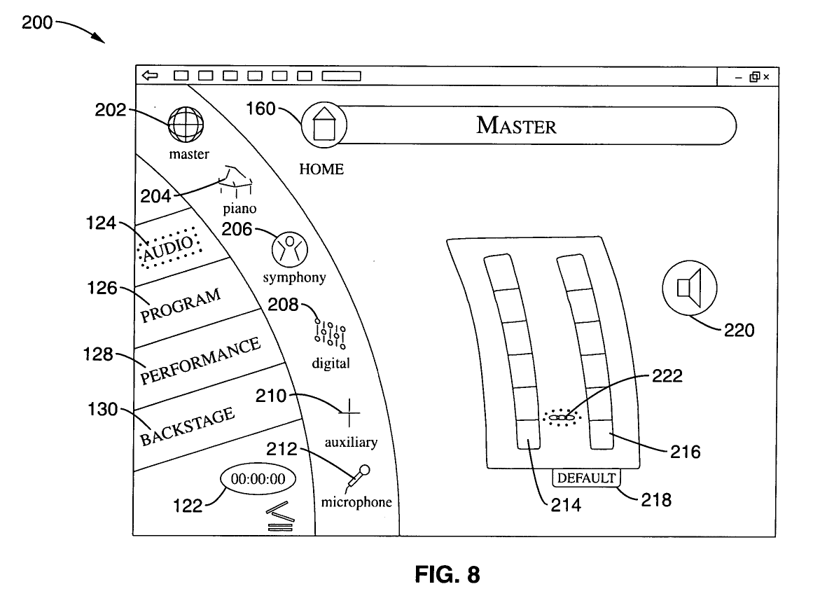

FIG. 8 shows the audio interface, generally designated 200, that can be accessed by toggling the “AUDIO” button 124 (FIG. 3) displayed at the main interface 100 (FIG. 3). FIG. 8 shows that the audio interface 200 includes the elapsed time meter 122, the “AUDIO” button 124, the “PROGRAM” button 126, the “PERFORMANCE” button 128, and the “BACKSTAGE” button 130 described above in conjunction with the main interface 100 (FIG. 3).

As shown in FIG. 8, the audio interface 200 further includes a “MASTER” button 202 that can be toggled to open the “MASTER” volume control screen which is the default control screen displayed when the “AUDIO” button 124 is toggled. A “piano” button 204 is provided and can be used to open a “PIANO” volume control screen, described below. Further, a “symphony” button 206 is provided and can be used to access a “SYMPHONY” volume control screen, described below. In a preferred embodiment, a “digital” button 208, an “auxiliary” button 210, and a “microphone” button 212 are also provided and can be used to access respective control screens linked to each button and described in detail below. Also shown in FIG. 8 is the “HOME” button 160 that can be toggled to return to the main interface 100 (FIG. 3).

As stated above, when the “AUDIO” button 124 is toggled, the “MASTER” volume control screen is the default screen displayed. The “MASTER” volume control screen includes a “Left Volume” control slider 214 that can be used to control the master volume output for the left speaker 58 (FIG. 3). Also, a “Right Volume” control slider 216 is provided and can be used to adjust the volume output for the right speaker 60 (FIG. 3). FIG. 8 further shows a “DEFAULT” volume button 218 that can be toggled to return the master left/right volume to a predetermined default setting. A “mute” button 220 is also provided and can be used to retain the positions of the volume control buttons 214, 216 while muting the master output volume. FIG. 8 further shows a “chain” button 222. This chain button 222 can be used to link and un-link the left and right volume control sliders 214, 216. When the chain button 222 is highlighted, the two volume control sliders 214, 216 are linked together. Moving one slider up or down will also move the other slider up or down. When the chain button 222 is not highlighted, the volume control sliders 214, 216 are not linked together and consequently the left and right volumes can be adjusted independently. Furthermore, re-linking the left and right volume control sliders 214, 216 by using the chain button 222, after independently moving one or the other of the sliders, and then moving one of the slider, the volume levels will remain in their relative positions to one another as they were prior to being re-linked.

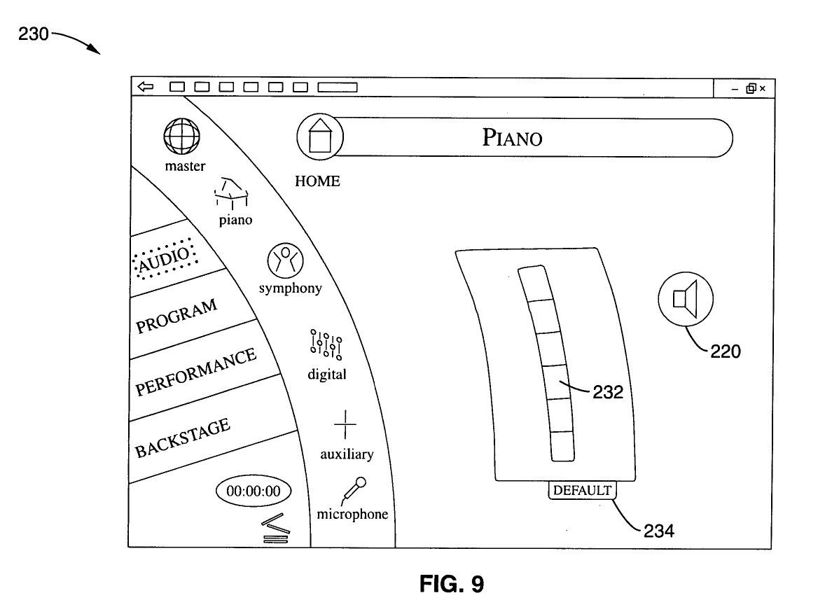

Referring now to FIG. 9, the “PIANO” volume control screen is shown and is generally designated 230. FIG. 9 shows that the “Piano” volume control screen 280 includes all the same buttons provided by the “MASTER” volume control screen (FIG. 8), except the left/right volume sliders. As shown, the “PIANO” volume control screen 230 includes a single “Volume” control slider 232 that can be used to control the volume of the piano 10 (FIG. 1). The PIANO” volume control screen 230 also includes a DEFAULT” button 234 that can be used to return the piano volume to a predetermined default volume.

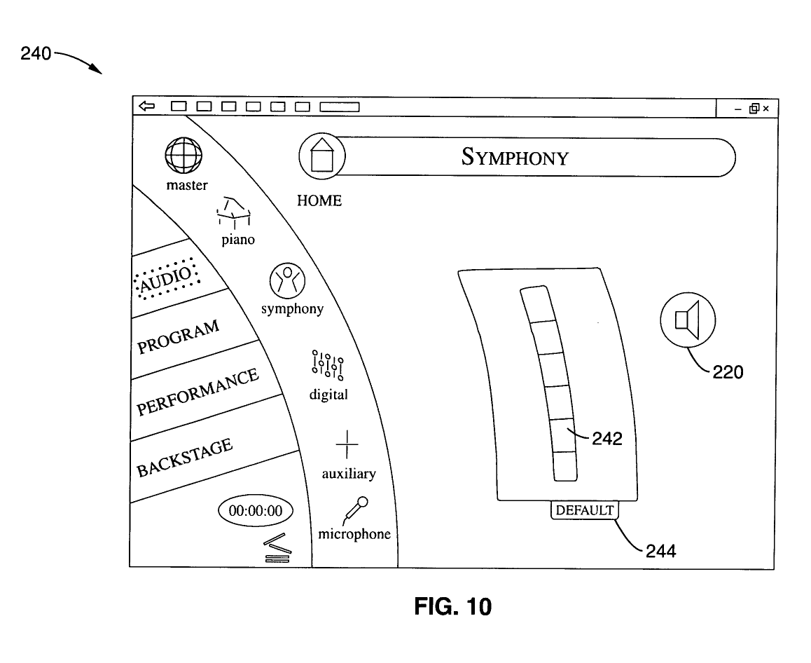

FIG. 10 shows the “SYMPHONY” volume control screen, designated 240. The “SYMPHONY” volume control screen 240 also includes all the same buttons provided by the “MASTER” volume control screen (FIG. 8) except the left/right volume sliders. As shown, the “SYMPHONY” volume control screen 240 includes a single “Volume” slider 242 that can be used to control the volume of the MIDI Synth symphony that can accompany the piano. A “DEFAULT” button 244 is also provided and can be used to return the accompanying volume to a predetermined default level.

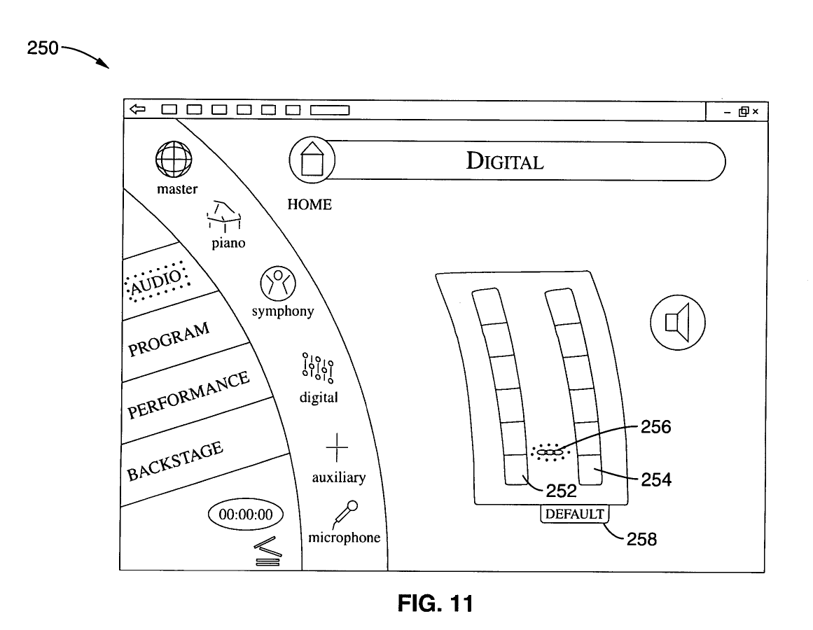

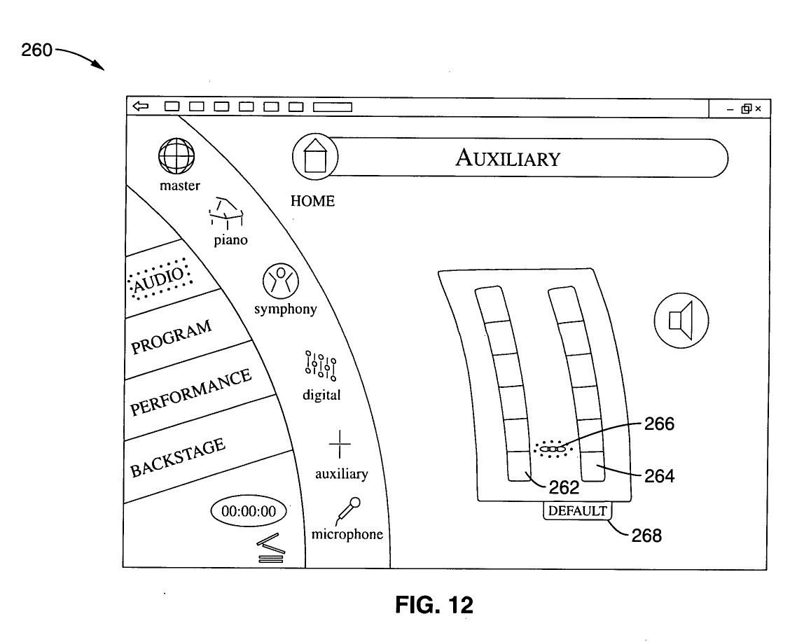

FIG. 11 shows the “DIGITAL” volume control screen, designated 250. Also, FIG. 12 shows the “AUXILIARY” volume screen, designated 260. Each of these screens 250, 260 includes the same buttons described in conjunction with the “MASTER” volume control screen 200 (FIG. 8). Turning now to FIG. 11, the “DIGITAL” volume control screen 250 has a left volume slider 252 and a right volume control slider 254. The left and right volume control sliders 252, 254 can be linked together by the chain button 256. Default settings can be set with button 258 The “DIGITAL” volume control screen 250 can be used to control the digital audio volume.

Similarly, the “AUXILIARY” volume screen 260 can be used to control the input volume of an auxiliary device 62. As seen in FIG. 12, Auxiliary control screen 260 has left volume control slider 262 and right volume control slider 264 that can be linked together by chain button 266. Default settings can be reached with button 268.

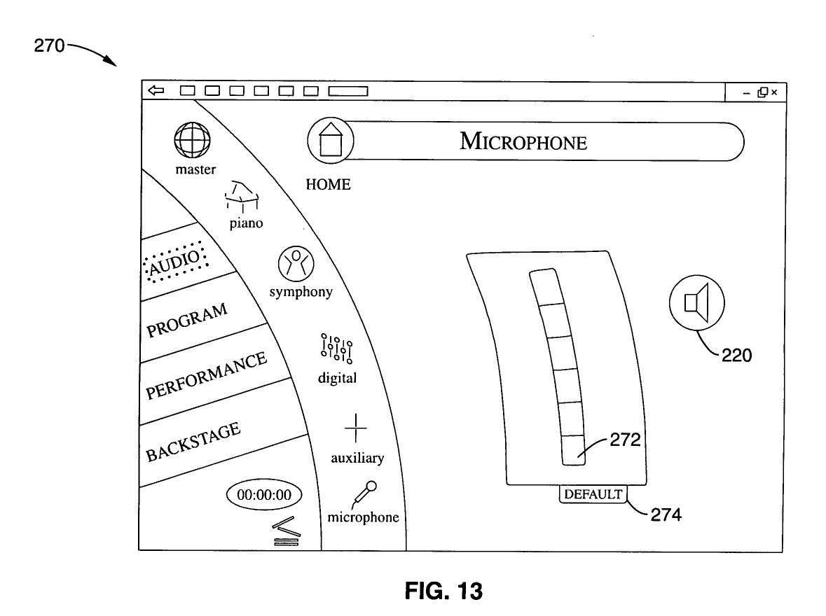

FIG. 13 shows the “MICROPHONE” volume control screen, designated 270, that can be used to control the microphone 64 (FIG. 2) input volume level with a single microphone volume control slider 272. Default settings can be set with button 274

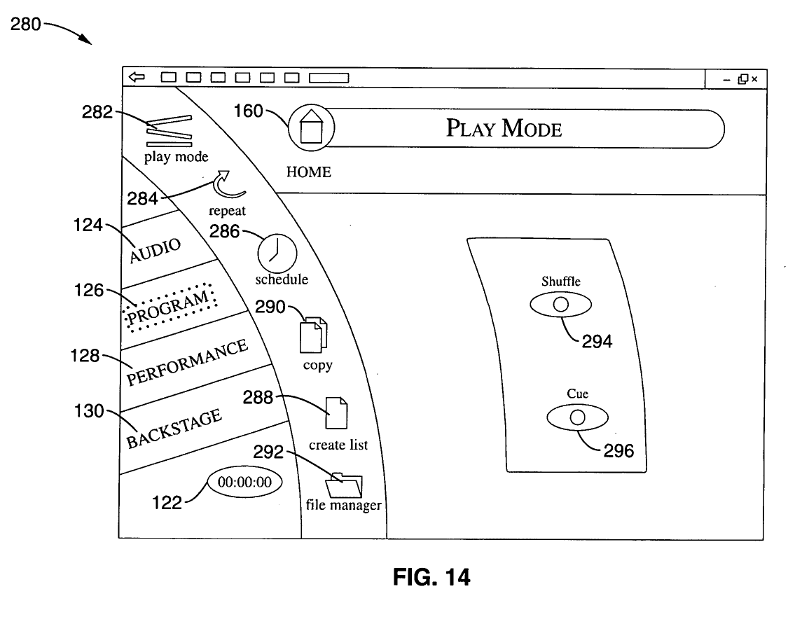

Referring to FIG. 14, the program interface is shown and is generally designated 280. It is to be understood that the program interface 280 can be accessed from the main interface 100 (FIG. 3) by toggling the “PROGRAM” button 126 of FIG. 3 as well as other screens.

FIG. 14 shows that the program interface 280 includes the elapsed time meter 122, the “AUDIO” button 124, the “PROGRAM” button 126, the “PERFORMANCE” button 128, and the “BACKSTAGE” button 130 described above in conjunction with the main interface 100 (FIG. 3). Additionally, the program interface 280 includes a “play mode” button 282 that can be toggled to open the “PLAY MODE” control screen. The “PLAY MODE” control screen is the default screen that is displayed when the “PROGRAM” button 126 is toggled.

FIG. 14 also shows that the program interface 280 includes a “repeat” button 284 that can be toggled to open the “REPEAT” screen, described below. A “schedule” button 286 is provided and can be toggled to open a “SCHEDULE” screen, described below. As shown in FIG. 14, the program interface 280 includes a “create list” button 288 and a “copy” button 290 that can be used to access a “CREATE” screen and a “COPY” screen, described below. Also, a “file manager” button 292 is included and can be toggled in order to access a “FILE” screen, described below. In addition, FIG. 14 shows the “HOME” button 160 that can be toggled to return to the main interface 100 (FIG. 3).

As described above, the “PLAY MODE” screen is the default screen that is displayed when the “PROGRAM” button 126 is toggled. The “PLAY MODE” screen includes a “Shuffle” button 294 that can be used to shuffle the songs being played by the piano 10 (FIG. 1) and a “Cue” button 296 that can be used to cause the piano 10 (FIG. 1) to play the songs in the requested order, but require the toggling of the “play/pause” button 110 (FIG. 4) before each song will start.

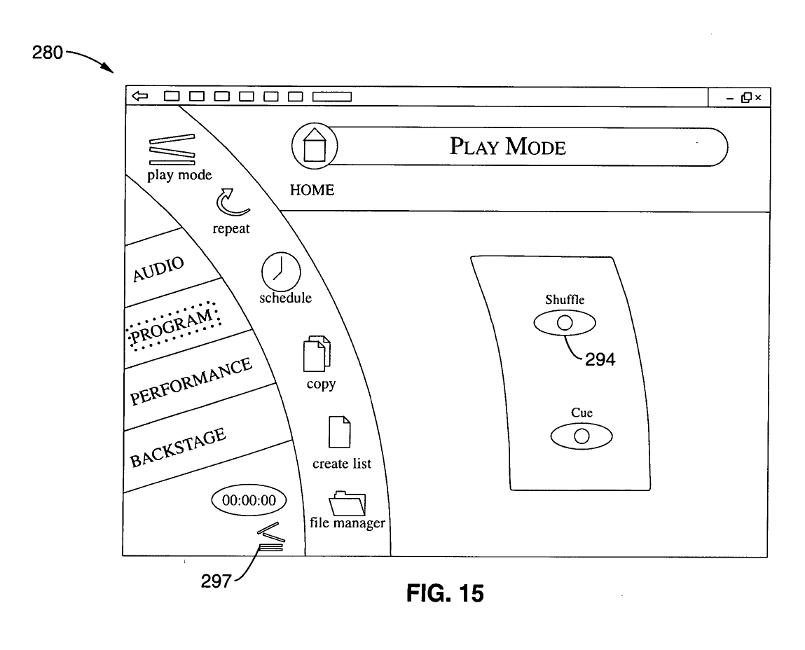

Turning now to FIG. 15, when the “Shuffle” button 294 of FIG. 14 is toggled, the green light in the center of the button will illuminate and the shuffle icon 297 will appear in the lower left corner of the display, just below the elapsed time meter 122.

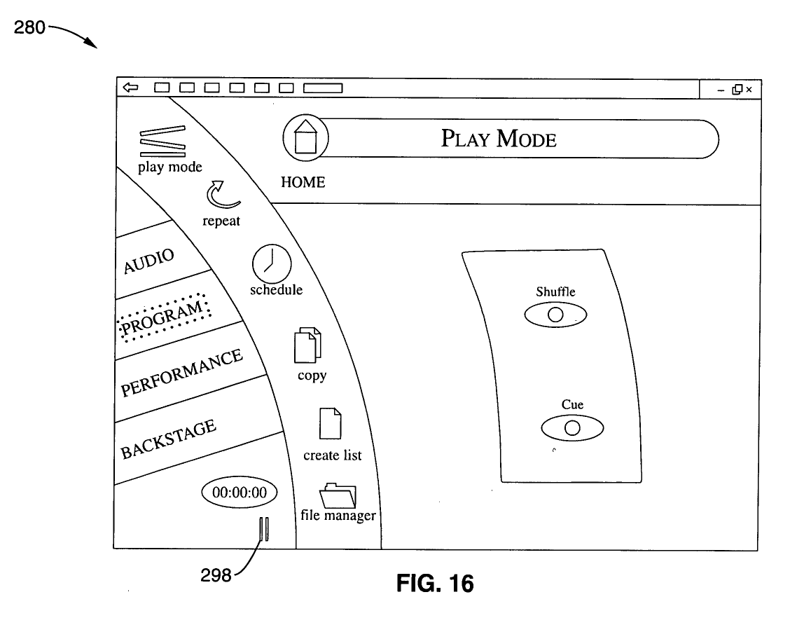

Similarly, when the “Cue” button 296 of FIG. 14 is toggled, the green light in the center of the button will illuminate and the cue icon 298 will appear in the lower left corner of the display, just below the elapsed time meter 122. As seen in FIG. 16, the “Cue” icon 298 will appear when cue button 296 is toggled.

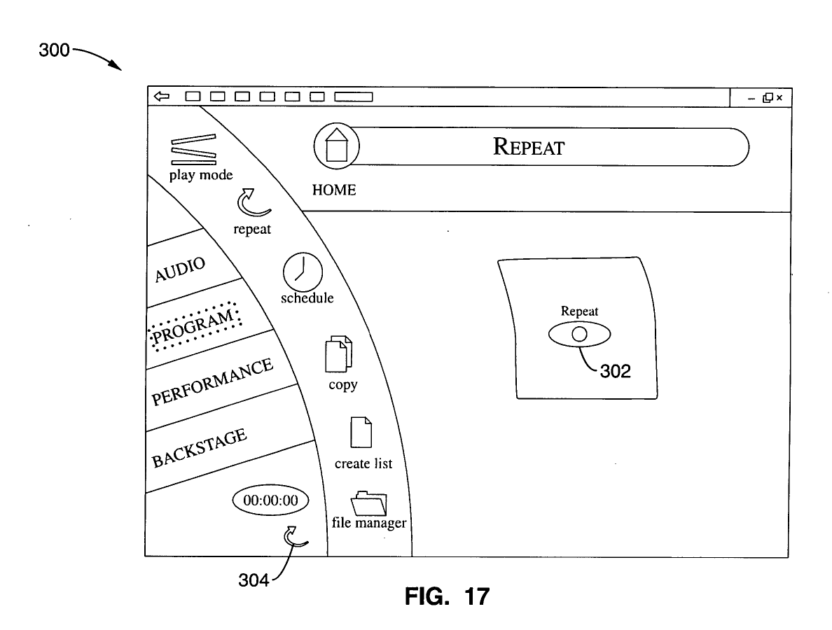

FIG. 17 shows the “REPEAT” screen, designated 300. The “REPEAT” screen 300 includes all of the buttons described in conjunction with the “PLAY MODE” screen, except the “Shuffle” button 294 and the “Cue” button 296 of FIG. 14. As shown in FIG. 17, the “REPEAT” screen 300 includes a “Repeat” button 302 that can be toggled to cause the piano 10 (FIG. 1) to repeat the selected song, the list of songs, the library, or the media being played. As with the shuffle and cue buttons 294, 296, when the “Repeat” button 302 is toggled, the green light in the center of the button will illuminate and the repeat icon 304 will appear in the lower left corner of the display, below the elapsed time meter 122.

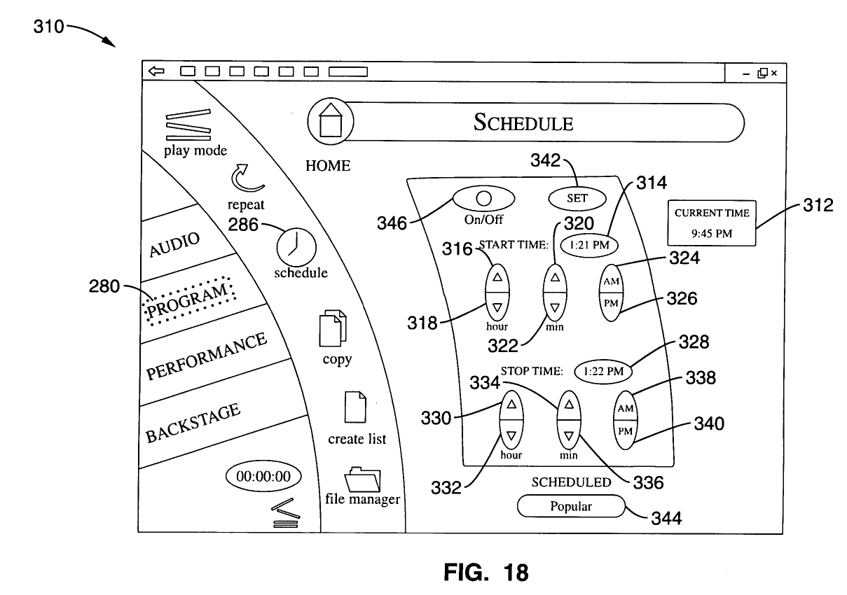

Referring now to FIG. 18, the “SCHEDULE” screen is shown and is designated 310. The “SCHEDULE” screen 310 can be accessed by toggling the “schedule” button 286 (FIG. 14) at the program interface 280 (FIG. 14). It is to be understood that the “SCHEDULE” screen 310 includes all of the buttons described in conjunction with the “PLAY MODE” screen, except the “Shuffle” button 294 and the “Cue” button 296 seen in FIG. 14. In addition to these buttons, the “SCHEDULE” screen 310 includes a clock 312 that shows the current time. Moreover, the “SCHEDULE” screen 310 includes a “START TIME” display 314 that can be used to display the desired start time for the piano 10 (FIG. 1) to begin playing. The desired start time can be adjusted by toggling an hour up button 316, an hour down button 318, a minute up button 320, a minute down button 322, an “AM” button 324, and a “PM” button 326.

FIG. 18 also shows that the “SCHEDULE” screen 310 includes a “STOP TIME” display 328 that can be used to display the desired stop time for the piano 10 (FIG. 1) to stop playing. The desired stop time can be adjusted by toggling an hour up button 330, an hour down button 332, a minute up button 334, a minute down button 336, an “AM” button 338, and a “PM” button 340. Once the desired start time and desired stop time are chosen, a “SET” button 342 can be toggled to confirm these times. FIG. 18 also shows a text display line 344 that can be used to show a playlist that is scheduled to be played. Furthermore, an “On/Off” button 346 is provided and can be used to turn the scheduled performance on or off. It is to be understood that the “SCHEDULE” screen 310 allows the user to program the piano 10 (FIG. 1) so that it will begin playing at a prescribed time and end playing at a prescribed time.

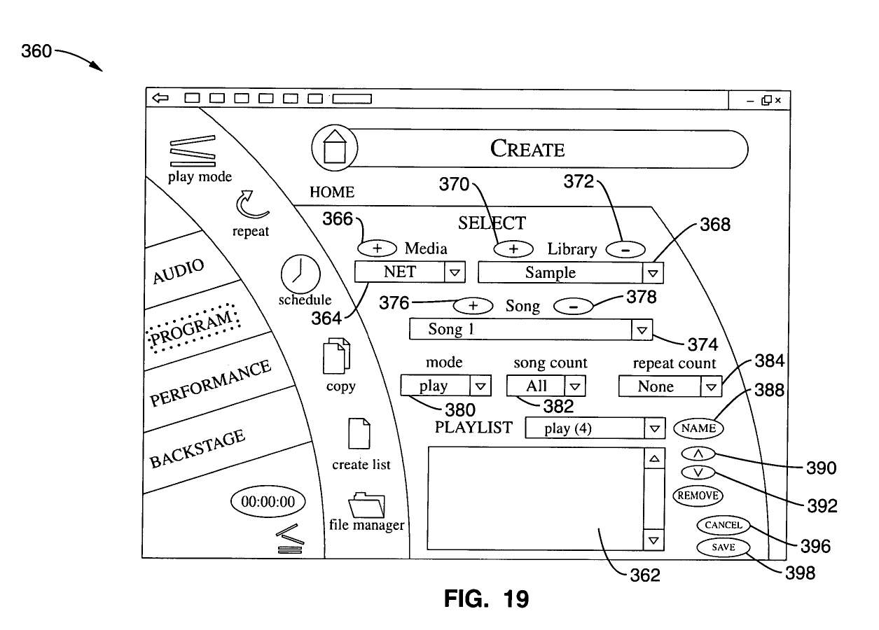

The “CREATE” screen is shown at FIG. 19 and is designated 360. The “CREATE” screen 360 can be accessed via the program interface 280 (FIG. 14) by toggling the “create list” button 288. As shown, the “CREATE” screen 360 includes a playlist window 362. A “Media” drop down window 364 is provided to select the music source, i.e., MX3, CD, or NET. A “+” (plus) button 366 can be pressed to add a particular source to the playlist. A “Library” drop down window 368 is used to select an individual library. A “+” (plus) button 370 and a “−” (minus) button 372 can be used to either add or exclude an individual library to or from the playlist. Furthermore, a “Song” drop down window 374 is provided to select a particular song. A “+” (plus) button 376 and a “−” (minus) button 378 are provided to either add or exclude the selected song to or from the playlist.

Still referring to FIG. 19, a “mode” drop down window 380 is provided. From this window the way the playlist is played back can be selected: normal play mode, shuffle, or cue. A “song count” drop down window 382 is also provided to allow the user to choose the number of songs to play from the playlist. All songs can be played from the list or a number between 1 (one) and ten (ten) can be selected. Additionally, a “repeat count” drop down window 384 is made available. From this window the number of times the playlist is repeated can be selected. The choices range from 0 (none), a count of 1 (one) to 10 (ten) times, or Infinite.

As shown in FIG. 19, a “PLAYLIST” drop down window 386 is included. This drop down window shows a list of all previously saved playlists from which the user can select. Also provided is a “NAME” button 388 which can be used to rename the currently selected playlist. Pressing the “NAME” button 388 causes an on-screen keyboard to appear allowing the user to edit the playlist name. Also, an “up” button 390 and a “down” button 392 are provided and can be used to move a selected song within the playlist up or down in the order. A “REMOVE” button 394 can be used to remove a selection (media, library, or song) from the playlist. A “CANCEL” button 396 is provided and can be used to stop the creation or editing of the current playlist. The playlist window 362 will be cleared and the “PLAYLIST” drop down window 386 will revert back to the default name for the next new playlist to be created. Also, a “SAVE” button 398 is provided and can be used to save newly created or edited playlists to the hard disk drive 22 (FIG. 2).

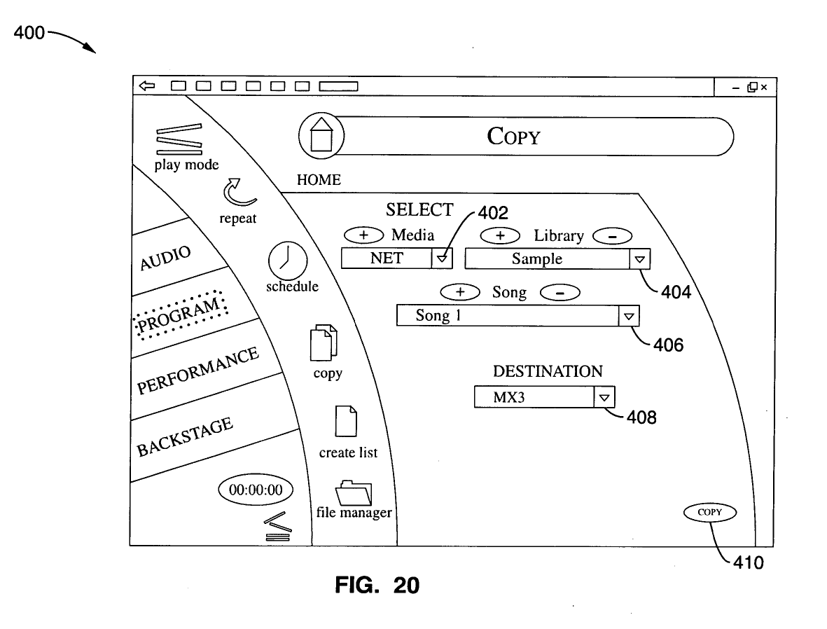

FIG. 20 shows the “COPY” screen, designated 400, that can be accessed by toggling the “copy” button 290 (FIG. 14). It is to be understood that the “COPY” screen 400 includes all of the buttons described in conjunction with the “PLAY MODE” screen, except the “Shuffle” button 294 (FIG. 14) and the “Queue Cue” button 296 (FIG. 14). The “COPY” screen 400 includes a “Media” drop down window 402, which is used to select the source media to be copied or copied from. Also included is a “Library” drop down window 404 from which the user can select the library to be copied or copied from. A “Song” drop down window 406 is also provided and is used to select a particular song to be copied. Furthermore, the “COPY” screen 400 contains a “DESTINATION” drop down window 408 that is used to select the location to which the media, the library, or the song is to be copied. Once these parameters have been selected the “COPY” button 410 can be toggled to begin the copying process.

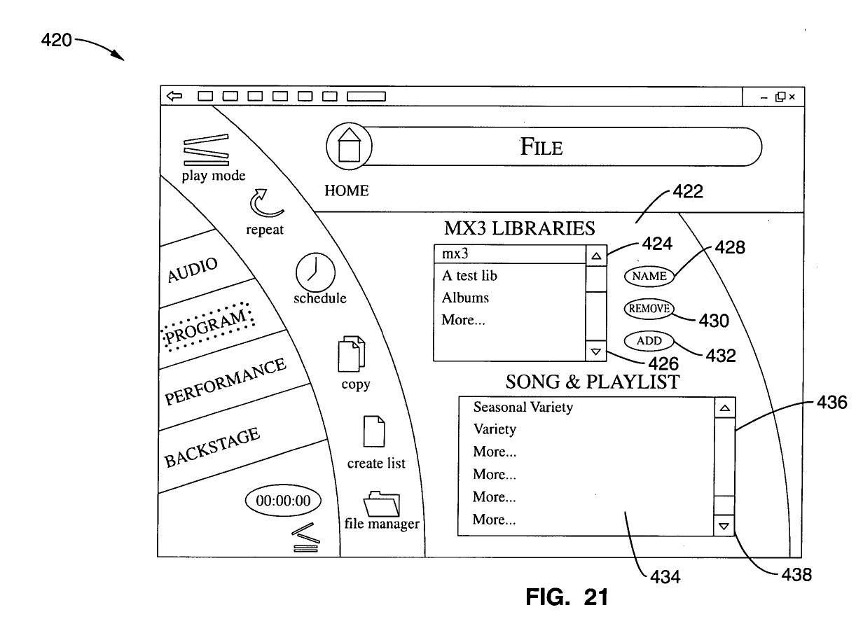

FIG. 21 shows the “FILE” screen, generally designated 420, that can be reached by toggling the “file manager” button 292 (FIG. 14). As shown in FIG. 21, the “FILE” Screen 420 contains an “MX3 LIBRARIES” window 422. This window displays a list of all the libraries currently stored on the MX3 media. An up arrow 424 and a down arrow 426 can be provided to scroll up/down the entire MX3 libraries list. A “SONGS & PLAYLIST” window 434 is also shown in FIG. 21. This window displays the songs and/or playlists within the library selected in the “MX3 LIBRARIES” window 422. An up arrow 436 and a down arrow 438 can be provided to scroll up and down the list of songs and playlists.

As shown in FIG. 21, the “FILE” screen 420 includes a “NAME” button 428 that can be use to change the name of a library, the name of a song, or the name of a playlist. When the “NAME” button 428 is toggled, an on-screen keyboard will appear and the user can change or modify the selected library title, song title, or playlist title. A “REMOVE” button 430 is also provided on the “FILE” screen 420. Toggling this button will remove the selected library, song, or playlist. Furthermore, an “ADD” button 432 can be toggled to add a library to the MX3 libraries list. When the “ADD” button 432 is toggled, an on-screen keyboard will appear and allow the user to type in a name for the new library.

In one embodiment, the system must verify that the desired operation is permissible before copying, moving, renaming, or deleting a file or library. If an operation is not allowed, the user should not be presented with the option to perform the action. For example, due to copyright restrictions, certain operations such as copying files to a removable medium may be restricted. It is to be understood that each of the above described operations can be applied to all files stored within the system. Moreover, these operations can be applied to multiple files, e.g., copying a playlist from the hard disk drive 22 of FIG. 2 to the floppy disk drive 30 of FIG. 2, for example.

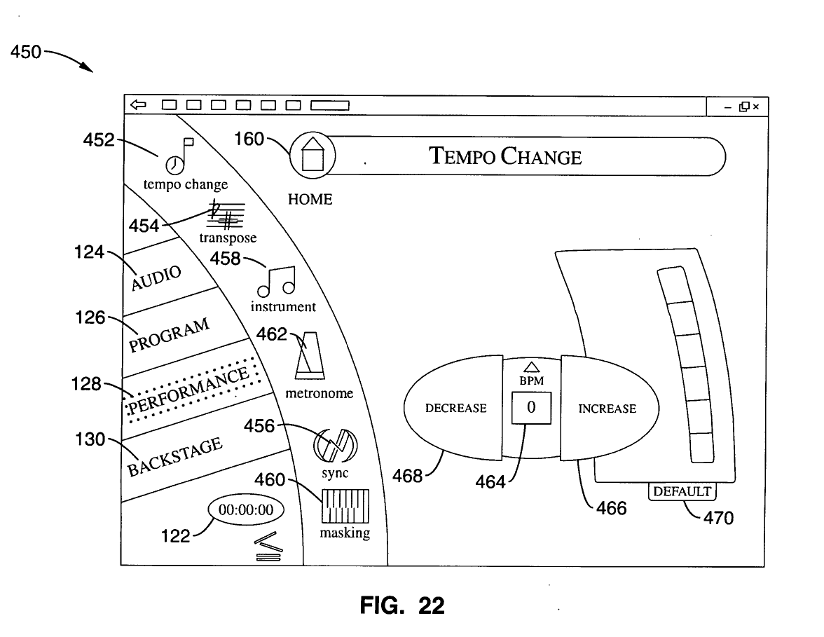

Referring now to FIG. 22, the performance interface is shown and is generally designated 450. As shown, the performance interface 450 includes the elapsed time meter 122, the “AUDIO” button 124, the “PROGRAM” button 126, the “PERFORMANCE” button 128, and the “BACKSTAGE” button 130 described above in conjunction with the main interface 100 (FIG. 3.)

Additionally, the performance interface includes a “tempo change” button 452 that can be used to access the “TEMPO CHANGE” screen, which is the default screen displayed by the performance interface when the “PERFORMANCE” button 128 is toggled. FIG. 22 also shows a “transpose” button 454 that can be toggled to reach the “TRANSPOSE” screen, described below. A “sync” button 456 is also provided and can be used to access a “SYNC” screen, describe below. Moreover, an “instrument” button 458 is shown and can be used to open an “INSTRUMENT” screen, described below. FIG. 22 further shows a “masking” button 460 that can be used to open the “CHANNEL MASKING” screen, described below. Also, a “metronome” button 462 is shown and can be use to access a “METRONOME” screen, described below. Also shown in FIG. 22 is the “HOME” button 160 that can be toggled to return to the main interface 100 (FIG. 3).

As stated above, the “tempo change” screen is the default screen that is presented when the performance interface is accessed. As shown in FIG. 22, the “TEMPO CHANGE” screen includes a beats per minute (BPM) display 464 that displays the change in tempo, from the originally recorded tempo, for the currently playing song, in beats per minute. Preferably, an “INCREASE” button 466 and a “DECREASE” button 468 are provided and can be used to increase or decrease the tempo at which a particular song is playing. A “DEFAULT” button 470 is also provided and can be used to return the tempo to a predetermined default value.

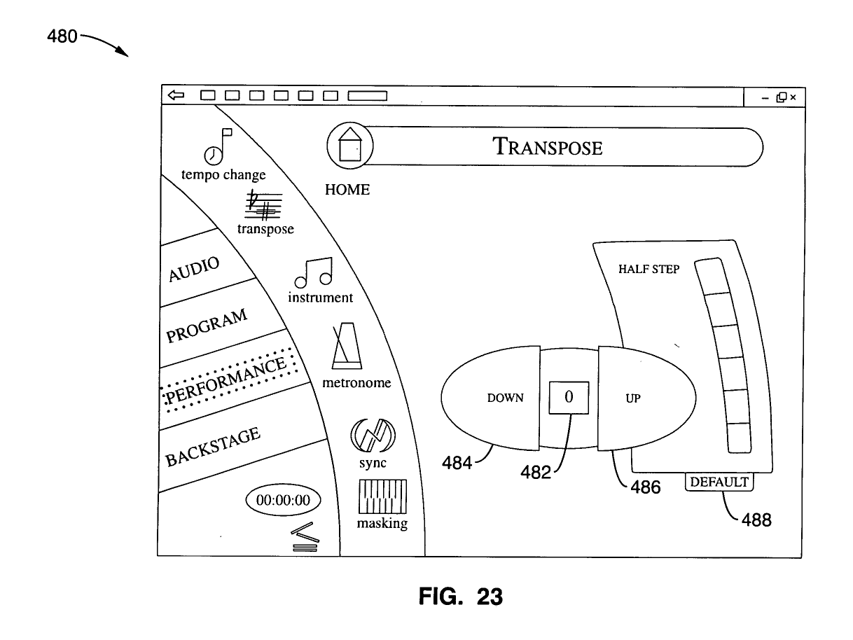

FIG. 23 shows the “TRANSPOSE” screen, generally designated 480. As shown, the “TRANSPOSE” screen 480 includes each of the buttons described in conjunction with the performance interface 450, except for the tempo controls. FIG. 23 shows that the “TRANSPOSE” screen 480 includes a “HALFSTEP” display 482, a “DOWN” button 484, and an “UP” button 486. These transpose controls can be used to control the key of playback. Each increment of transpose shifts all subsequent notes up one half step. Similarly, each decrement shifts all subsequent notes down one half step. FIG. 23 shows that the “TRANSPOSE” screen 480 further includes a “DEFAULT” button 488 that can be used to restore the transpose value to a predetermined default value.

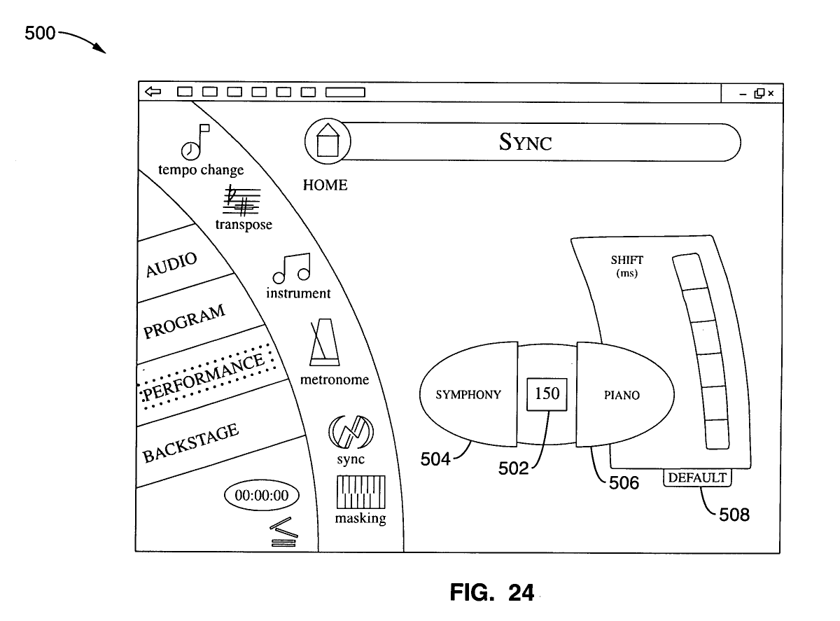

Referring to FIG. 24, the “SYNC” screen is shown and is generally designated 500. As shown, the “SYNC” screen 500 includes each of the buttons described in conjunction with the performance interface 450, except for the temp controls. FIG. 24 shows that the “SYNC” screen 500 includes a “SHIFT” display 502 that shows the delay between the piano and accompanying symphony parts of a performance. The delay is due to the time it takes for a hammer to strike a string within the piano 10 (FIG. 1). The system automatically sets the sync value, but a user can toggle a “SYMPHONY” button 504 or a “PIANO” button 506 in order to adjust the delay value. A “DEFAULT” button 508 is also provided and can be used to return the delay value to the predetermined setting.

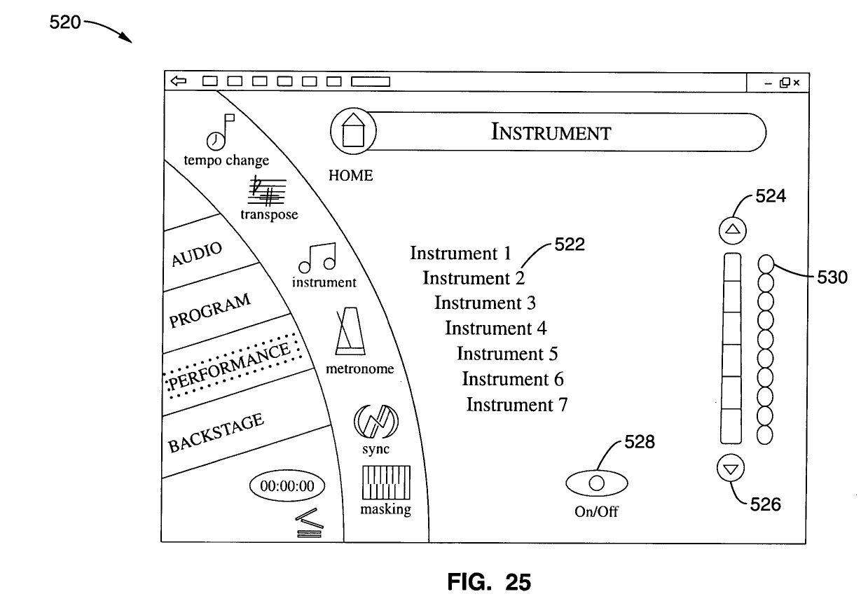

FIG. 25 shows the “INSTRUMENT” screen, generally designated 520. The instrument selection feature allows a user to play the piano and have a symphony accompaniment mimic his or her performance. It is also used to select the instrument or sound in which the user wishes to record music. As shown, the “INSTRUMENT” screen 520 includes each of the buttons described in conjunction with the performance interface 450, except for the tempo controls. FIG. 25 shows that the “INSTRUMENT” screen 520 includes an accompanying instrument list 522 that the user can peruse using an up arrow 524 and a down arrow 536. Also, an “On/Off” button 528 is provided and can be used to turn the instrument feature on or off. Furthermore, letter buttons 530 are provided and can be used to quickly skip to instruments in the list that begins with that letter. In the embodiment shown, the instruments on the list are MIDI instruments, each of which can be listed in a text file.

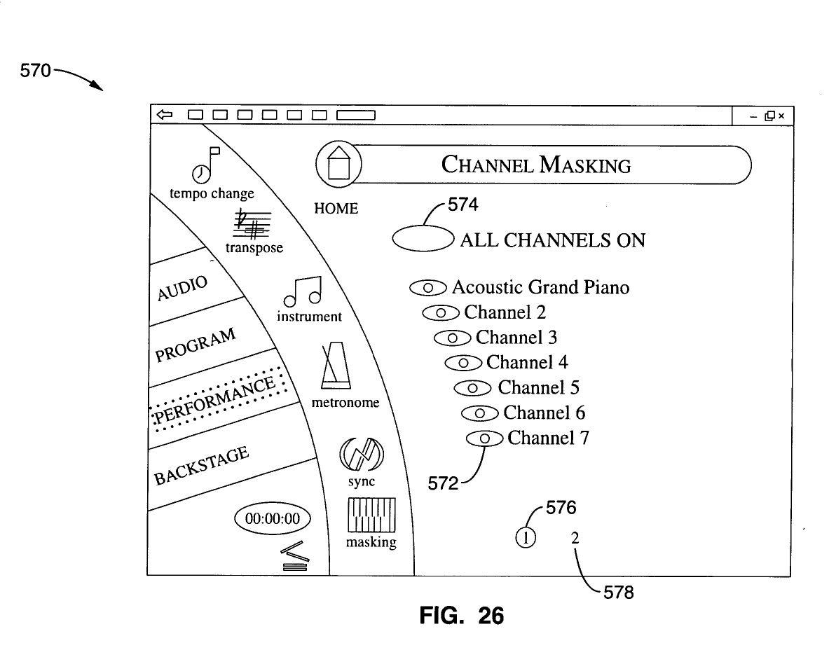

Referring now to FIG. 26, the “CHANNEL MASKING” screen is shown and is generally designated 570. This is the default screen displayed when the “masking” button 460 is toggled. As shown, the “CHANNEL MASKING” screen 570 includes each of the buttons described in conjunction with the performance interface 450, except for the tempo controls. FIG. 26 further shows that the “CHANNEL MASKING” screen 570 includes plural “Channel” buttons 572, each associated with a respective channel. In the present non-limiting example, there are sixteen (16) channel buttons 572. As shown, the “CHANNEL MASKING” screen 570 also includes an “ALL CHANNELS ON” button 574 that can be toggled in order to turn all the representative channels on. FIG. 26 further shows a “1” (one) button 576 and a “2” (two) button 578 that can be used to toggle between the first masking screen, shown in FIG. 26, and the second masking screen, described below. It is to be understood that MIDI data is sent on one or more of the 16 MIDI channels and the channel mask feature allows a user to turn off one or more of these channels.

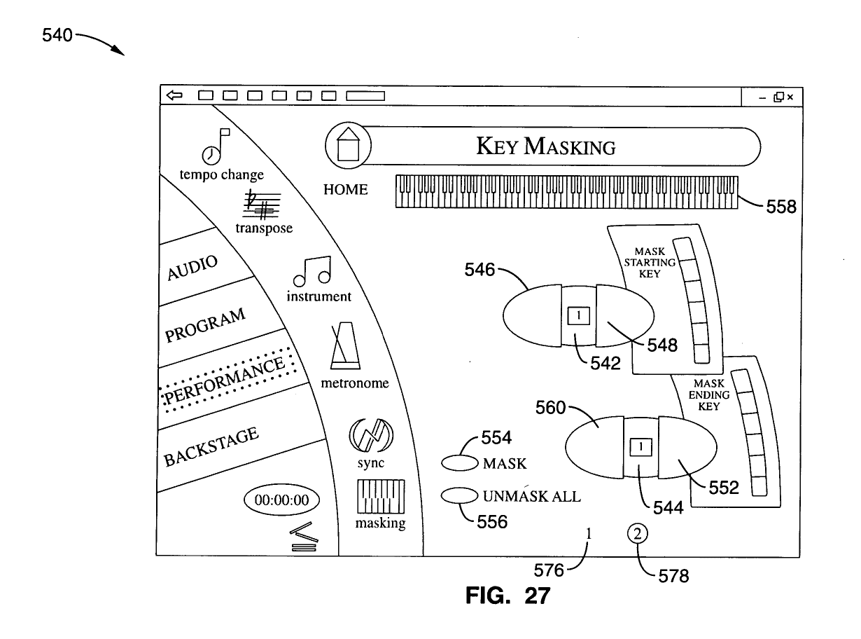

FIG. 27 shows the “KEY MASKING” screen, generally designated 540. As shown, the “KEY MASKING” screen 540 includes each of the buttons described in conjunction with the performance interface 450, except for the tempo controls. FIG. 27 shows that the “KEY MASKING” screen 540 includes a “MASK STARTING KEY” display 542 and a “MASK ENDING KEY” display 544. The mask starting key can be chosen using a first “down” button 546 and a first “up” button 548. Also, the mask ending key can be chosen using a second “down” button 550 and a second “up” button 552. As shown in FIG. 27, a “MASK” button 554 and an “UNMASK ALL” button 556 are provide and can be used to mask or unmask the keys within the selected range. The “KEY MASKING” screen 540 also includes the “1” (one) button 576 and the “2” (two) button 578 that can be used to toggle between the first “MASKING” screen (FIG. 26) and the second “MASKING” screen 540. Additionally, FIG. 27 includes a representative piano keyboard 588. This keyboard shows the actual keys being selected for masking.

It is to be understood that the key masking feature allows a user to turn off a range or multiple ranges of keys on the piano keyboard. This feature can be useful when learning to play the piano because it allows a user to manually play part of the performance. It can be appreciated that each key on the piano 10 (FIG. 1) can be masked or unmasked.

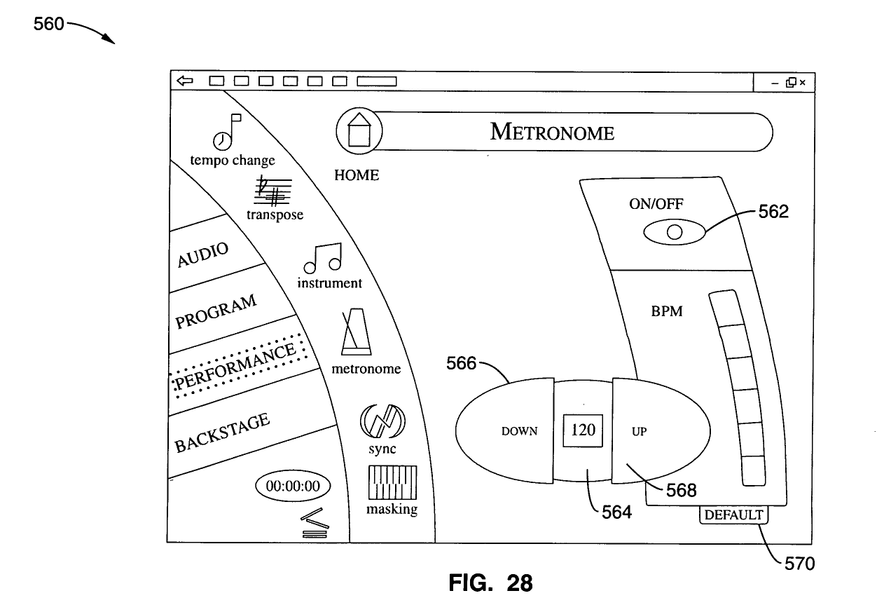

FIG. 28 shows the “METRONOME” screen, generally designated 560. Included is an “ON/OFF” button 562 that can be toggled to turn a metronome on or off. Moreover, a “BPM” (beats per minute) display 564 is provided. The beats per minute of the metronome can be adjusted using a left arrow button 566 and a right arrow button 568. A “DEFAULT” button 570 is also provided and can be used to return the beats power minute to the predetermined default value.

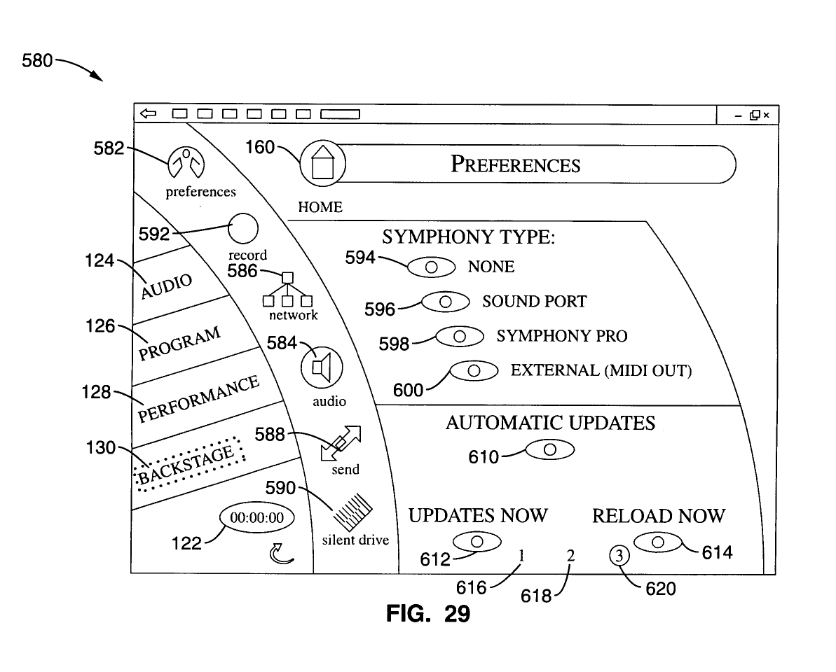

Turning now to FIG. 29, the backstage interface designated 580 is generally shown. It will be appreciated that the backstage interface can be accessed by toggling the “BACKSTAGE” button 130 at the main interface 100 shown in FIG. 3. As shown in FIG. 29, the backstage interface 580 can include the elapsed time meter 122, the “AUDIO” button 124, the “PROGRAM” button 126, the “PERFORMANCE” button 128, and the “BACKSTAGE” button 130 described above in conjunction with the main interface 100.

The backstage interface can be used primarily to adjust the settings of the system. In addition to the above-described buttons, the backstage interface 580 can include a “preferences” button 582 that can be used to access the first “PREFERENCES” screen, which is the default screen displayed by the backstage interface when the “BACKSTAGE” button 130 is toggled.

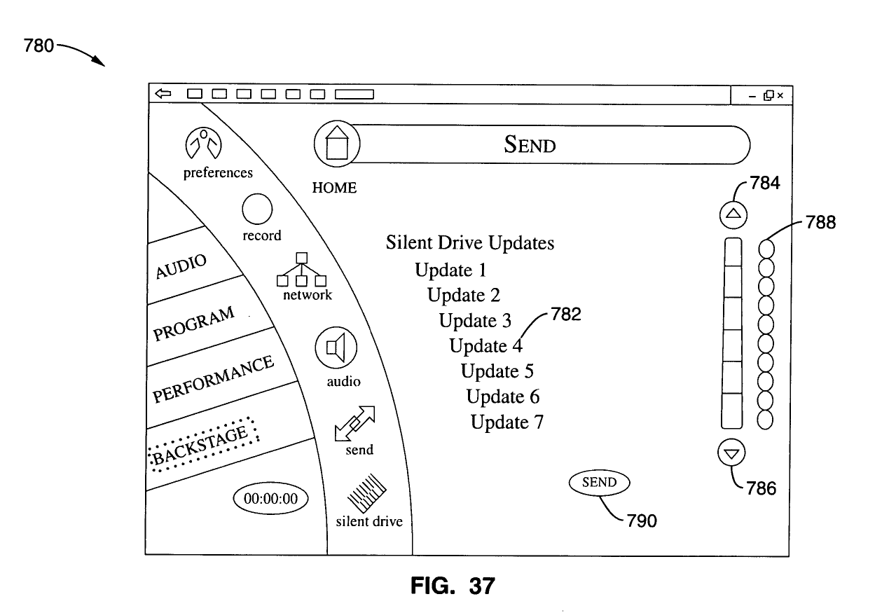

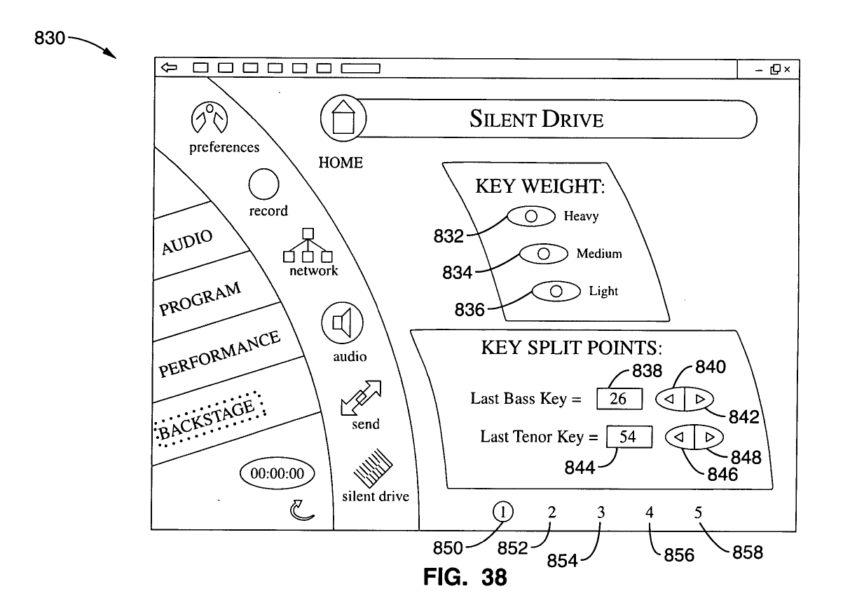

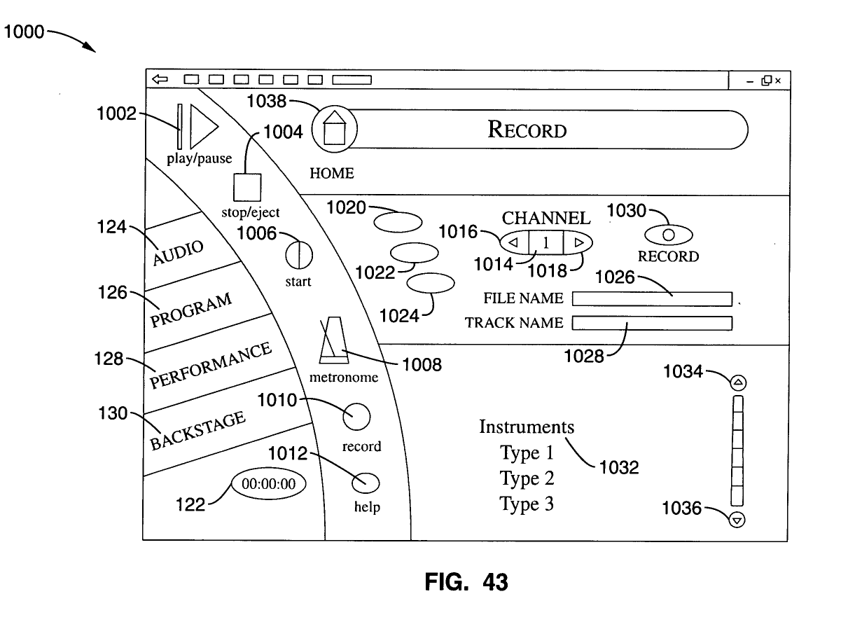

FIG. 29 also shows a “network” button 586 that can be used to access a general “NETWORK” settings screen, described below. Moreover, a “send” button 588 is shown and can be used to open a “SEND” screen as seen in FIG. 37. FIG. 29 further shows a “silent drive” button 590 that can be used to open a series of “SILENT DRIVE” screens shown in FIG. 38 through FIG. 42. Also, a “record” button 592 is shown and can be used to access the record settings interface shown in FIG. 43. An “audio” button 584 is provided and can be used to access an audio settings screen, described below. Also shown in FIG. 29 is the “HOME” button 160 that can be toggled to return to the main interface 100 (FIG. 3).

As stated above, the first “PREFERENCES” screen 580 is the default screen that is presented when the backstage interface is accessed in this embodiment. As shown in FIG. 29, the first “PREFERENCES” screen 580 includes a number of buttons that can be toggled to choose the type of symphony that is to accompany the piano. For example, a “None” button 594 can be toggled to choose no symphony. A “Sound Font” button 596 can be toggled to choose sound fonts as the source for the symphony.

It is to be understood that this is a software source for the symphony. FIG. 29 further shows that a “Symphony Pro” button 598 can be toggled in order to choose a hardware source for the symphony. Also, an “External” button 600 can be toggled in order to choose an external source as the source for the symphony.

As shown in FIG. 29, the first “PREFERENCES” screen 580 also includes an “AUTOMATIC UPDATES” button 610 which can be toggled on or off. When the “AUTOMATIC UPDATES” button 610 is on, the system will look for system update files over the Internet connection, providing an Internet connection is available. Also provided is an “UDATE NOW” button 612 that can be used to have the system check for system updates immediately. A “RELOAD NOW” button 614 is included and can be used to refresh the browser window if the browser being used does not have a refresh button of its own. FIG. 29 also includes a “1” (one) button 616, a “2” (two) button 618, and a “3” (three) button 620 that can be used to switch between the first “PREFERENCES” screen, shown in FIG. 29, the second “PREFERENCES” screen, described below, and the third “PREFERENCES” screen, described below.

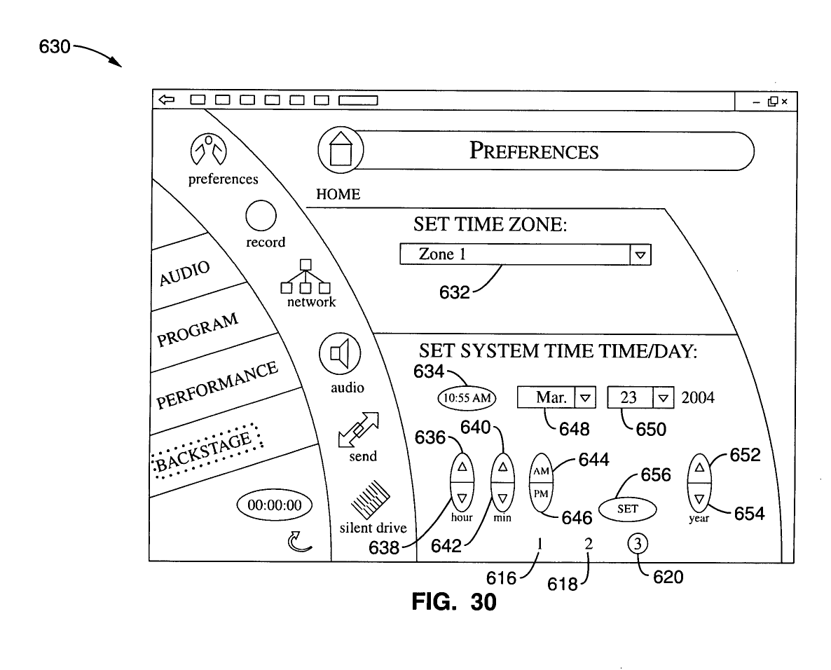

Referring to FIG. 30, the second “PREFERENCES” screen is shown and is generally designated 630. The second “PREFERENCES” screen 630 includes all of the buttons described in conjunction with the first “PREFERENCES” screen 580, except for the symphony and update buttons. The second “PREFERENCES” screen 630 includes a “SET TIME ZONE” drop down window 632, which is used to select the local time zone of the user. This setting is useful for maintaining unique time features such as daylight savings time.

As shown in FIG. 30, the second “PREFERENCES” screen 630 also includes a system clock 634. The system clock 634 can be adjusted by using an hour up button 636, an hour down button 638, a minute up button 640, a minute down button 642, an “AM” button 644, and a “PM” button 646. FIG. 30 also includes a month drop down window 648, and a day drop down window 650 for selecting the current month and day. A year up arrow 652 and a year down arrow 654 are included for selecting the current year. A “SET” button 656 is also included and can be toggled in order to set the time on the system clock 634 and to save the time and date to the hard disk drive 22 (FIG. 3). FIG. 30 also includes the “1” (one) button 616, the “2” (two) button 618, and the “3” button 620 that can be used to toggle between the first “PREFERENCES” screen 580, the second “PREFERENCES” screen, shown in FIG. 30, and the third “PREFERENCES” screen, described below.

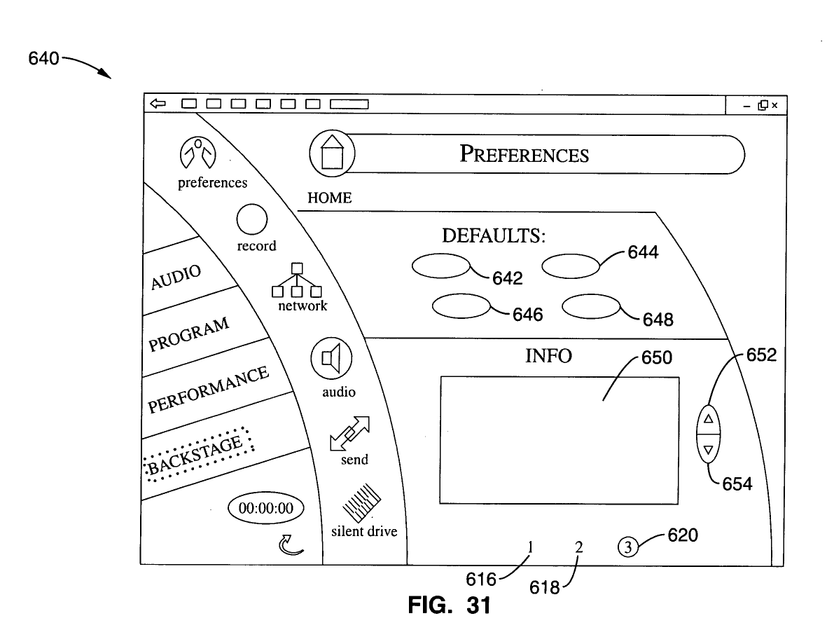

Referring to FIG. 31, the third “PREFERENCES” screen is shown and is generally designated 640. The third “PREFERENCES” screen 640 includes all of the buttons described in conjunction with the first “PREFERENCES” screen 580, except the symphony and update buttons. As shown, the third “PREFERENCES” screen 640 can include a “Save New Defaults” button 642 which can be used to save all current system settings as the default settings. A “Load Defaults” button 644 is provided and can be used to load default settings from the hard disk drive 22 shown in FIG. 3. FIG. 31 also includes a “Copy to Floppy” button 646 that can be used to save the system default settings to a floppy disk, which allows the user to have a back up copy of the default settings in case a problem occurs with those stored on the hard disk drive 22 (FIG. 3). Also, a “Load from Floppy” button 648 can be included. The “Load from Floppy” button 648 allows the user to retrieve the default settings previously saved to a floppy disk.

FIG. 31 also shows an “INFO” window 650. This “INFO” window 650 displays system information including, operating system version, installed system options, hard disk drive space available, etc. An up arrow button 652 and a down arrow button 654 can be used to scroll up and down through the system information shown in the “INFO” window 650. The third “PREFERENCES” screen 640 also includes the “1” (one) button 616, the “2” (two) button 618, and the “3” (three) button 620 which can be used to toggle between the first “PREFERENCES” screen 580, the second “PREFERENCES” screen 630, and the third “PREFERENCES” screen 640.

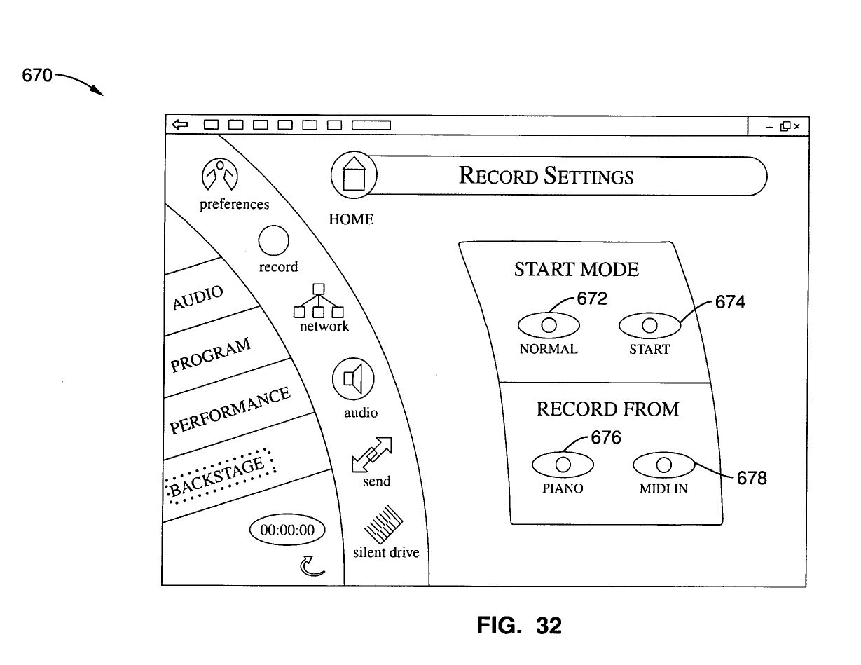

Referring now to FIG. 32, the “RECORD SETTINGS” screen is shown and is generally designated 670. The “RECORD SETTINGS” screen 670 includes all of the buttons described in conjunction with the first “PREFERENCES” screen 580 (FIG. 29), except for the symphony and update buttons. As shown in FIG. 32, the “RECORD SETTINGS” screen 670 includes a “NORMAL” button 672 and a “SMART” button 674. These buttons 672, 674 can be used to specify when the system is to begin recording the user. In the “NORMAL” mode, the system begins recording as soon as the user presses the “record” button 118 (FIG. 4). In the “SMART” mode, the system begins recording as soon as data is received, i.e., the user starts playing. FIG. 32 also includes a “PIANO” button 676 and a “MIDI IN” button 678 which are used to tell the system which input to expect to receive the data to be recorded. If the “PIANO” button 676 is selected, then the system will look to receive the data directly from the piano 10 (FIG. 1). If the “MIDI IN” button 678 is selected, then system will look to receive the data from some external MIDI device.

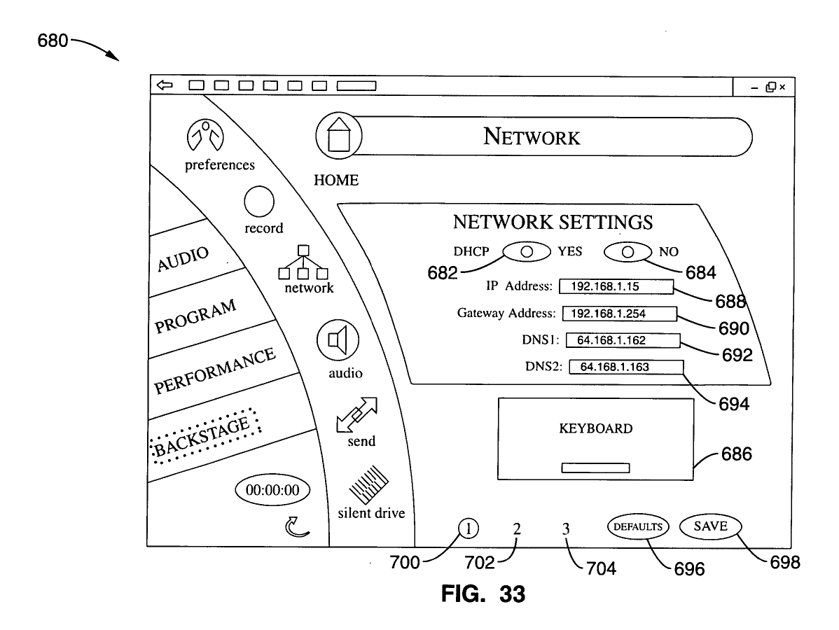

Referring to FIG. 33, the first “NETWORK” screen is shown and is generally designated 680. The first “NETWORK” screen 680 can be accessed by toggling the “network” button 586 (FIG. 29). As shown, the first “NETWORK” screen 680 includes all of the buttons described in conjunction with the first “PREFERENCES” screen 580 (FIG. 29), except for the symphony and update buttons. The first “NETWORK” screen 680 includes a “Yes” button 682 and a “No” button 684 that can be used to turn the Dynamic Host Configuration Protocol (DHCP) on or off. Additionally, a keyboard 686 is presented (if the system is in the unlocked mode) and can be used to input information to an “IP Address” input field 688, a “Gateway Address” input field 690, a “DNS1” (domain name server one) input field 692, and a “DNS2” (domain name server two) input field 694. FIG. 33 also shows a “Restore Defaults” button 696 which can be toggled to restore the factory network settings. A “SAVE” button 698 is provided to save all network settings to the hard disk drive 22 (FIG. 2). Also included is a “1” (one) button 700, a “2” (two) button 702, and a “3” (three) button 704 that can be used to toggle between the first “NETWORK” screen 680, the second “NETWORK” screen, described below, and the third “NETWORK” screen, described below.

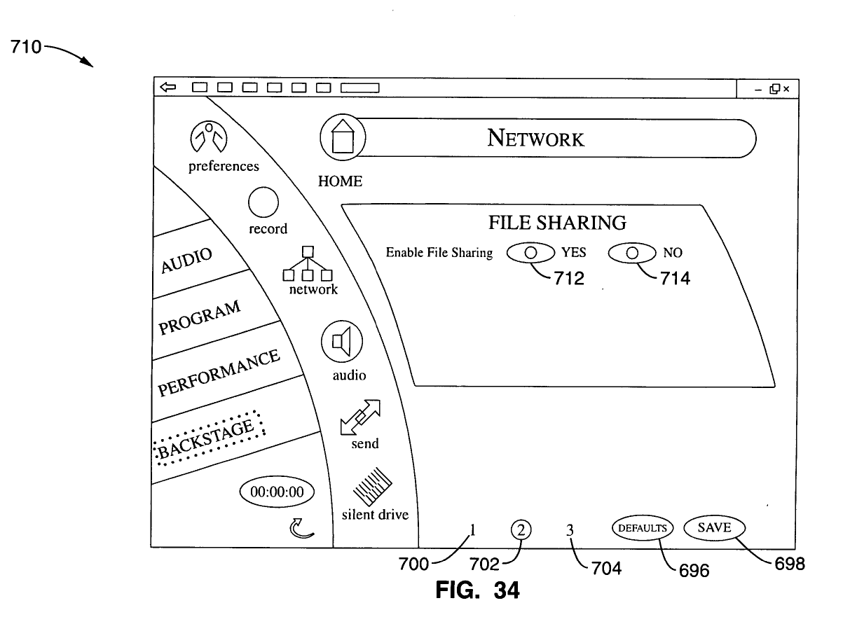

FIG. 34 shows the second “NETWORK” screen that is generally designated 710. As shown, the second “NETWORK” screen 710 includes all of the buttons described in conjunction with the first “PREFERENCES” screen 580 (FIG. 29), except for the symphony and update buttons. In addition, a “Yes” button 712 and a “No” button 714 are provided and can be used to enable or disable file sharing. The second “NETWORK” screen 710 also includes the “Restore Defaults” button 696 and the “SAVE” button 698 which can be used to restore the factory default network settings or save all network settings. Additionally, the second “NETWORK” screen 710 includes the “1” (one) button 700, the “2” (two) button 702, and the “3” (three) button 704 that can be used to toggle between the first “NETWORK” screen 680, the second “NETWORK” screen 710, and the third “NETWORK” screen, described below.

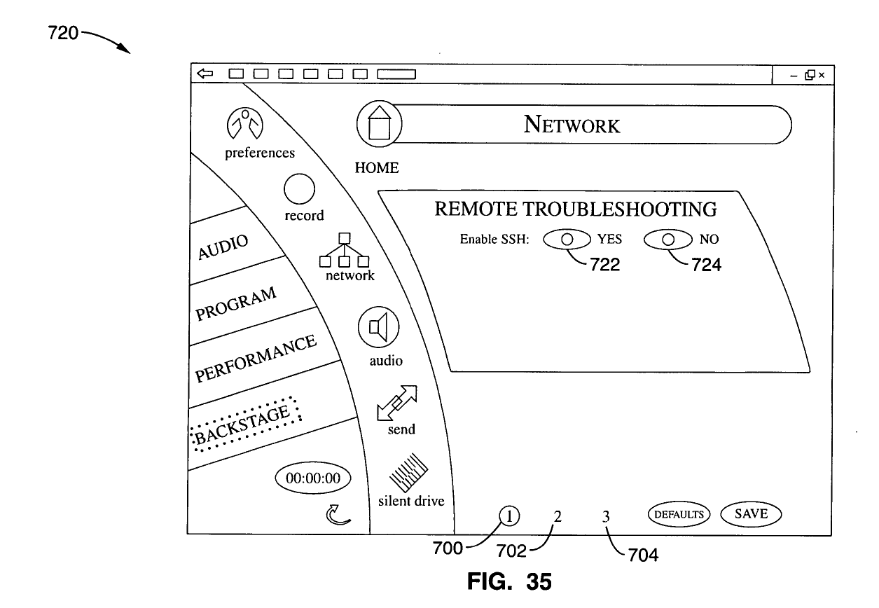

Referring now to FIG. 35, the third “NETWORK” screen is shown and is generally designated 720. As shown, the third “NETWORK” screen 720 includes all of the buttons described in conjunction with the first “PREFERENCES” screen 580 (FIG. 29), except for the symphony and update buttons. A “Yes” button 722 and a “No” button 724 are included and can be used to enable or disable the SSH (Secure Shell) remote troubleshooting feature. The third “NETWORK” screen also includes the “1” (one) button 700, the “2” (two) button 702, and the “3” (three) button 704 that can be used to toggle between the first “NETWORK” screen 680, the second “NETWORK” screen 710, and the third “NETWORK” screen 720.

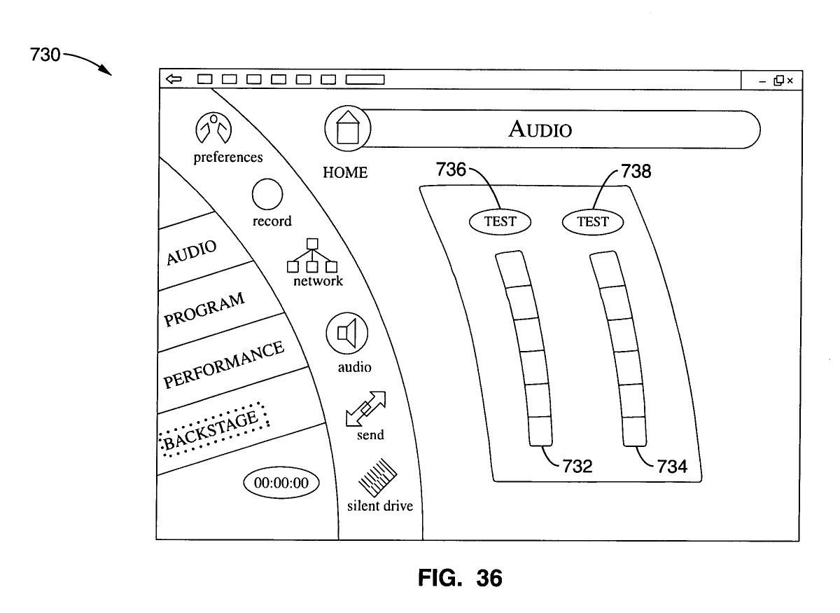

Referring now to FIG. 36, the “AUDIO” setup screen is shown and is generally designated 730. As shown, the “AUDIO” setup screen 730 includes all of the buttons described in conjunction with the first “PREFERENCES” screen 580 (FIG. 29), except for the symphony and update buttons. The “AUDIO” setup screen 730 can be accessed by toggling he “audio” button 584 (FIG. 29) displayed at the “PREFERENCES” screen 580 (FIG. 29). The “AUDIO” setup screen includes a “Minimum Digital Volume” control slider 732 that can be used to set the desired minimum volume level to be played for digital audio. Also, a “Minimum Symphony Volume” control slider 734 is provided and can be used to set the desired minimum volume level to be played for symphony accompaniment audio. Furthermore, a first “TEST” button 736 is provided and can be used to test and listen to the set minimum digital volume to see if it is acceptable. A second “TEST” button 738 is provided and can be used to test and listen to he set minimum symphony accompaniment volume to see if it is acceptable.

Referring now to FIG. 37, the “SEND” screen is shown and is generally designated 780. As shown, the “SEND” screen 780 includes all of the buttons described in conjunction with the first “PREFERENCES” screen 580 (FIG. 29), except for the symphony and update buttons. In addition the “SEND” screen 780 includes an update list 782 that displays the updates available for any system component. FIG. 37 shows an up button 784 and a down button 786 that can be used to scroll through the update list 782. Furthermore, letter buttons 788 are provided and can be used to quickly skip to entries within the update list 782 that begin with that letter. A “SEND” button 790 is also included and can be used to send or download the selected file to the appropriate system component, i.e., a Silent Drive board or an Optical board.

FIG. 38 shows the first “SILENT DRIVE” settings screen that is generally designated 830. The first “SILENT DRIVE” settings screen 830 can be accessed by toggling the “silent drive” button 590 presented by the backstage interface 580. It is to be understood that the first “SILENT DRIVE” settings screen and a second “SILENT DRIVE” settings screen can be used to control the operation of the mechanism that actuates the piano keys and causes it them to “play.”

As shown, the first “SILENT DRIVE” settings screen 830 includes all of the buttons described in conjunction with the backstage interface 580 (FIG. 29), except the symphony and update buttons. In addition to those buttons described above, the first “SILENT DRIVE” settings screen 830 includes a “Heavy” button 832, a “Medium” button 834, and a “Light” button 836. These buttons can be used to select the weight of the piano keys.

As shown in FIG. 38, a “Last Bass Key” display 838 is shown on the first “SILENT DRIVE” settings screen 830. The last bass key for the piano 10 (FIG. 1) can be selected by using a first left arrow button 840 and a first right arrow button 842. FIG. 38 also shows a “Last Tenor Key” display 844. The last tenor key for the piano 10 (FIG. 1) can be selected by using a second left arrow button 846 and a second right arrow button 848. FIG. 35 38 also shows a “1” (one) button 850, a “2” (two) button 852, a “3” (three) button 854, a “4” (four) button 856, and a “5” (five) button 858. These numbered buttons can be used to move between the five “SILENT DRIVE” settings screens.

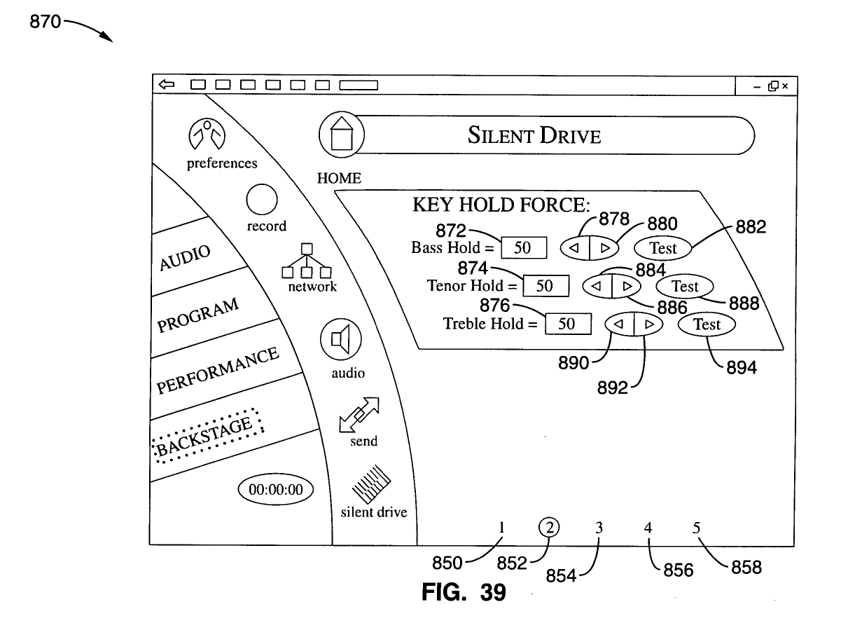

Referring to FIG. 39, a second “SILENT DRIVE” settings screen is shown and is generally designated 870. The second “SILENT DRIVE” settings screen 870 can be accessed by toggling the “2” (two) button 852 displayed at the first “SILENT DRIVE” settings screen 830 (FIG. 38). As shown, the second “SILENT DRIVE” settings screen 870 includes all of the buttons described in conjunction with the backstage interface 580 (FIG. 29), except the symphony and update buttons.

In addition to those buttons described above, the second “SILENT DRIVE” settings screen 870 includes a “Bass Hold” display 872, a “Tenor Hold” display 874, and a “Treble Hold” display 876. The bass hold force can be adjusted by toggling a first left arrow button 878 and a first right arrow button 880. Also, the adjusted bass hold force can be tested by toggling a first “TEST” button 882. The tenor hold force can be adjusted by toggling a second left arrow button 884 and a second right arrow button 886. The adjusted tenor hold force can be tested by toggling a second “TEST” button 888. Moreover, the treble hold force can be adjusted by toggling a third left arrow button 890 and a third right arrow button 892. The adjusted treble hold force can be tested by toggling a third “TEST” button 894.

FIG. 39 shows that the second “SILENT DRIVE” settings screen 870 also includes the “1” (one) button 850, the “2” (two) button 852, the “3” (three) button 854, the “4” (four) button 856, and the “5” (five) button 858, described above, that can be use to move between the five “SILENT DRIVE” settings screens.

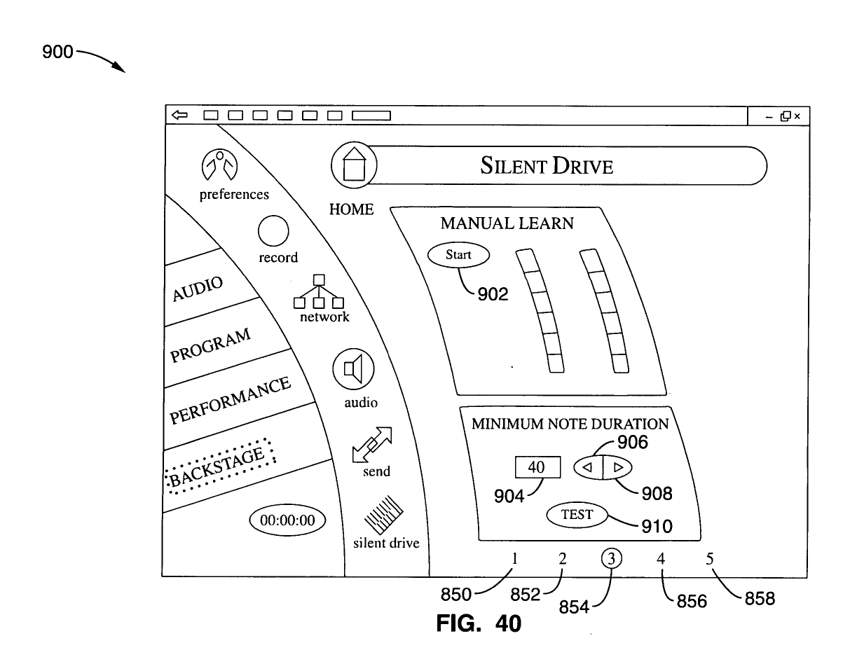

FIG. 40 shows the third “SILENT DRIVE” settings screen, designated 900 that can be accessed by toggling the “3” (three) button 852 displayed at the first “SILENT DRIVE” settings screen 830 (FIG. 38). As shown the third “SILENT DRIVE” settings screen 900 includes all of the buttons described in conjunction with the backstage interface 580 (FIG. 29), except the symphony and update buttons.

In addition to those buttons described above, the third “SILENT DRIVE” settings screen 900 includes a “START” button 902 that can be pressed to commence manual learning. Moreover, a note duration display 904 is included and can be used to display the minimum note duration. The minimum note duration can be adjusted using a left arrow button 906 and a right arrow button 908. A “TEST” button 910 can be used to test the note duration once it is selected.

As shown in FIG. 40, the third “SILENT DRIVE” settings screen 900 also includes the “1” (one) button 850, the “2” (two) button 852, the “3” (three) button 854, the “4” (four) button 856, and the “5” (five) button 858, described above, that can be used to move between the five “SILENT DRIVE” settings screens.

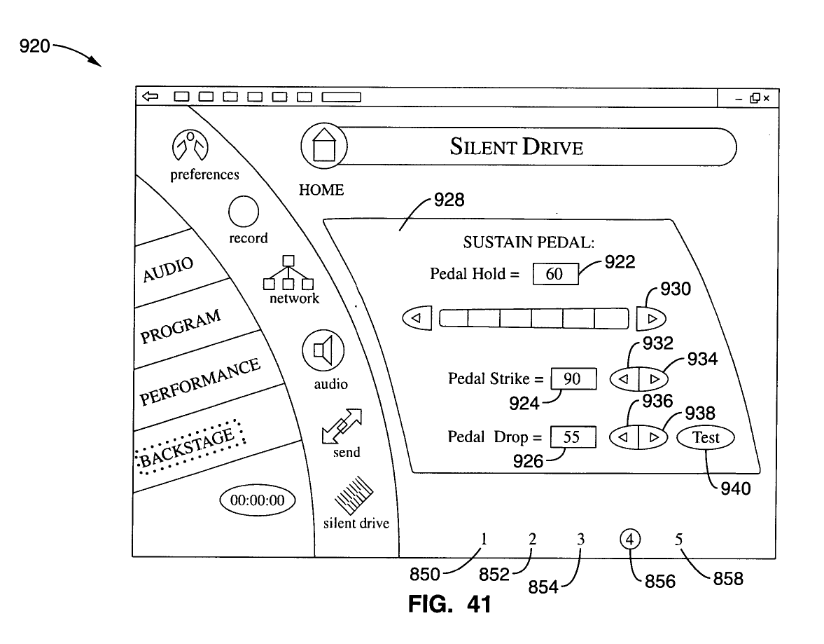

FIG. 41 shows the fourth “SILENT DRIVE” settings screen, designated 920 that can be accessed by toggling the “4” (four) button 856 displayed at the first “SILENT DRIVE” settings screen 830 (FIG. 38). As shown, the fourth “SILENT DRIVE” settings screen 920 includes all of the buttons describe in conjunction with the backstage interface 580 (FIG. 29), except the symphony and update buttons.

In addition to those buttons described above, the fourth “SILENT DRIVE” settings screen 920 includes a “Pedal Hold” display 922, a “Pedal Strike” display 924, and a “Pedal Drop” display 926. The pedal hold can be adjusted by toggling a first left arrow button 928 and a first right arrow button 930. The pedal strike can be adjusted by toggling a second left arrow button 932 and a second right arrow button 934. Moreover, a pedal drop can be adjusted by toggling a third left arrow button 936 and a third right arrow button 938. The adjusted settings can be tested by pressing a “TEST” button 940.

As shown in FIG. 41, the fourth “SILENT DRIVE” settings screen 920 also includes the “1” (one) button 850, the “2” (two) button 852, the “3” (three) button 854, the “4” (four) button 856, and the “5” (button) 858, described above, that can be used to move between the five “SILENT DRIVE” settings screens.

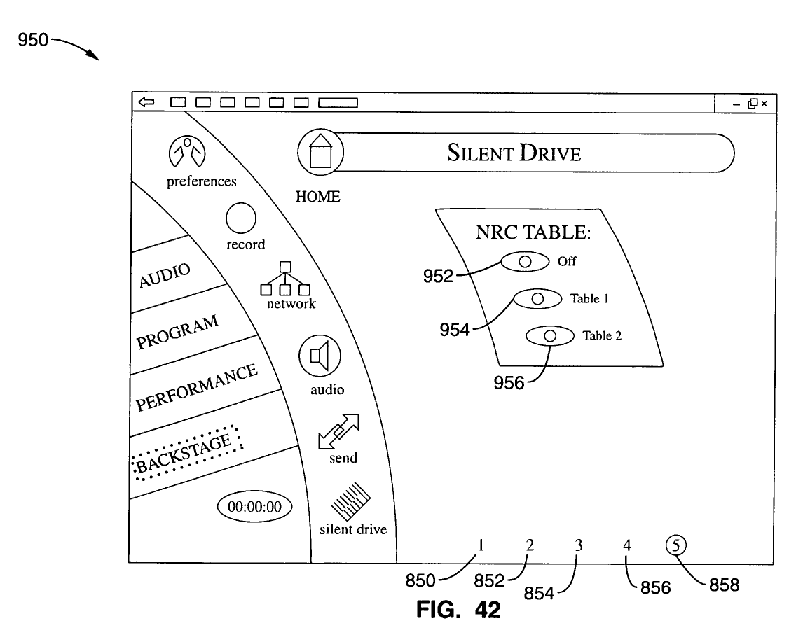

Referring now to FIG. 42, the fifth “SILENT DRIVE” settings screen is shown and is generally designated 950. The fifth “SILENT DRIVE” settings screen 950 can be accessed by toggling the “5” (five) button 858 displayed at the first “SILENT DRIVE” settings screen 830 (FIG. 38). As shown, the fifth “SILENT DRIVE” settings screen 950 includes all of the buttons described in conjunction with the backstage interface 580 (FIG. 29) except the symphony and update buttons.

In addition to those buttons described above, the fifth “SILENT DRIVE” settings screen 950 includes and “Off” button 952 that can be used to turn an NRC table off. Moreover, a “Table 1” button 954 and a “Table 2” button 956 are provided and can be used to choose a first NRC table or a second NRC table.

FIG. 42 further shows that the fifth “SILENT DRIVE” settings screen 950 can include the “1” (one) button 850, the “2” (two) button 852, the “3” (three) button 854, the “4” (four) button 856, and the “5” (button) 858, described above, that can be used to move between the five “SILENT DRIVE” settings screens.

Referring now to FIG. 43, the record interface is shown and is generally designated 1000. It can be appreciated that the record interface 1000 can be accessed, e.g., by toggling the “Record” button 118 (FIG. 3) at the main interface 100 (FIG. 3). As shown in FIG. 43, the record interface 1000 can include the elapsed time meter 122, the “Audio” button 124, the “Program” button 126, the “Performance” button 128, and the “Backstage” button 130 described above in conjunction with the main interface 100 (FIG. 3).

The record interface 1000 includes a “Play/Pause” button 1002 and a “Stop/Eject” button 1004. In addition, a “Start Mode” button 1006 is included and can be used to define the mode in which the system will start recording, described below. Further, the record interface 1000 includes a metronome button 1008 that will open a record interface metronome screen, described below. The record interface 1000 also includes a record button 1010 and a help button 1012. The “Record” screen is the default screen that appears when the record interface is accessed.

The “Record” screen includes a “Channel” display 1014. The channel, e.g., one through sixteen (1-16) can be selected using a left arrow button 1016 and a right arrow button 1018. It is to be understood that the selected channel will be used for the next track to be recorded. Preferably, the first the “Record” screen includes a “New Recording” button 1020 and an “Existing Recording” button 1022. These buttons 1020, 1022 can be toggled in order to indicate whether the current recording is a new recording or an existing recording. In a preferred embodiment, if a user selects an existing recording, the file can be automatically converted to a Type 1 SMF and the new recording will be appended as a new track. Files listed in an existing file, e.g., “My Recordings,” can be presented to the user as choices for selecting an existing recording.

In the embodiment shown in FIG. 43, the “Record” screen includes a “Name Track” button 1024 that can be toggled to open a second “Record” screen, described below. As shown, a “File Name” input field 1026 and a “Track Name” input field 1028 are provided. Information can be input thereto from the second record screen, described below. A “Record” button 1030 is also provided.

Additionally, as shown in FIG. 43, an instrument list 1032 can be provided by the first “Record” screen. An up arrow button 1034 and a down arrow button 1036 can be used to scroll up and down through the instrument list 1032. The instrument list 1032 allows a user to select the instrument to record. The instrument list 1032 is essentially a list of 128 General MIDI (GM) instruments that the system provides. The instrument list 1032 is preferably provided as a text file. Preferably, the instrument setting applies to the next track recorded. Moreover, in a preferred embodiment, if the channel is set to a particular channel, e.g., channel ten (10), a list of corresponding sounds, e.g., percussion sounds, can be displayed instead of the standard instrument list, described above. FIG. 43 also shows a “Home” button 1038 that can be toggled to return a user to the main interface 100 (FIG. 3).

The buttons of “Record” screen shown in FIG. 43, may lead to sub screens. For example, if the “name track” button 1024 is toggled, a screen with a keyboard that can be used to input information to a “File Name” input field and the “Track Name” input field may be provided. In a preferred embodiment, all recordings can be stored in a predetermined file, e.g., a “My Recordings” file in the hard disk drive 22 (FIG. 1). Each time a user records to the same file, a new track can be generated. The “Track Name” input field can allow the user to name the track that is to be recorded next.

Toggling the “Start Mode” button 1006 (FIG. 43) at the record interface 1000, a screen including an “Immediate” button and a “Smart” button that can be used to specify the when the system is to begin recording the user may be provided. In the “Immediate” mode, the system begins recording as soon as the user presses a record button. In the “Smart” mode, the system begins recording as soon as data is received, i.e., the user starts playing.

As shown in FIG. 43, the screen includes a “Metronome” button 1008 that can be toggled to turn a metronome on or off. By toggling button 1008, a “BPM” (beats per minute) display may be provided. The beats per minute of the metronome can be adjusted using a left arrow button and a right arrow button.

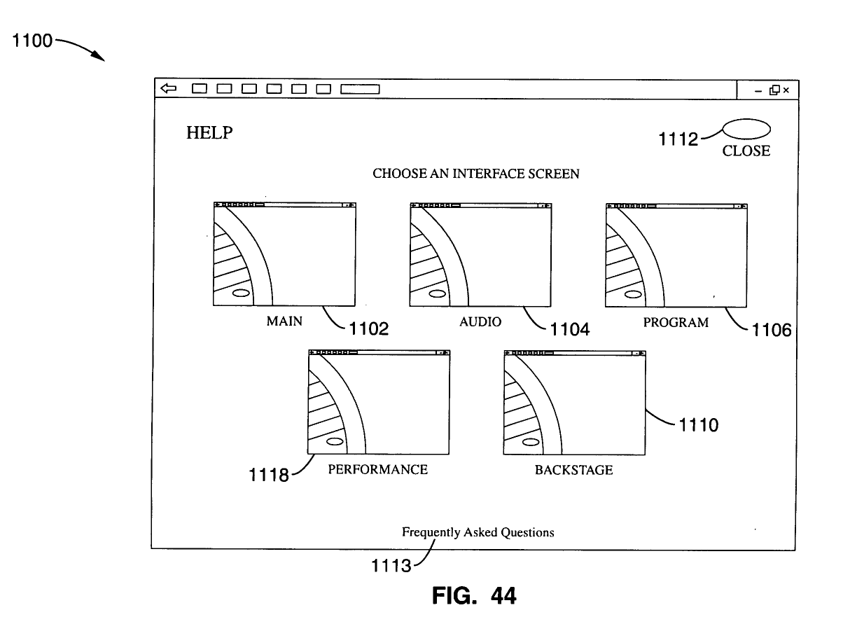

Referring now to FIG. 44 through FIG. 49, the help interface is shown and is generally designated 1100. It is to be understood that the help interface 1100 can be reached by pressing the “help” button 120 (FIG. 4) presented on any of the four storage device interfaces 150, 170, 180, and 190 (FIGS. 4, 5, 6, and 7). As shown in FIG. 44, the help interface 1100 can include a main interface thumbnail 1102, an audio interface thumbnail 1104, a program interface thumbnail 1106, a performance interface thumbnail 1108, and a backstage interface thumbnail 1110. FIG. 44 shows that the help interface 1100 also includes a “CLOSE” button 1112 that can be toggled to close the help interface. Furthermore, the help interface 1100 preferably provides an “Or touch here for Frequently Asked Questions” link 1113 in this embodiment. The sections of the interface screens can be toggled to open helpful descriptions of the function of those buttons.

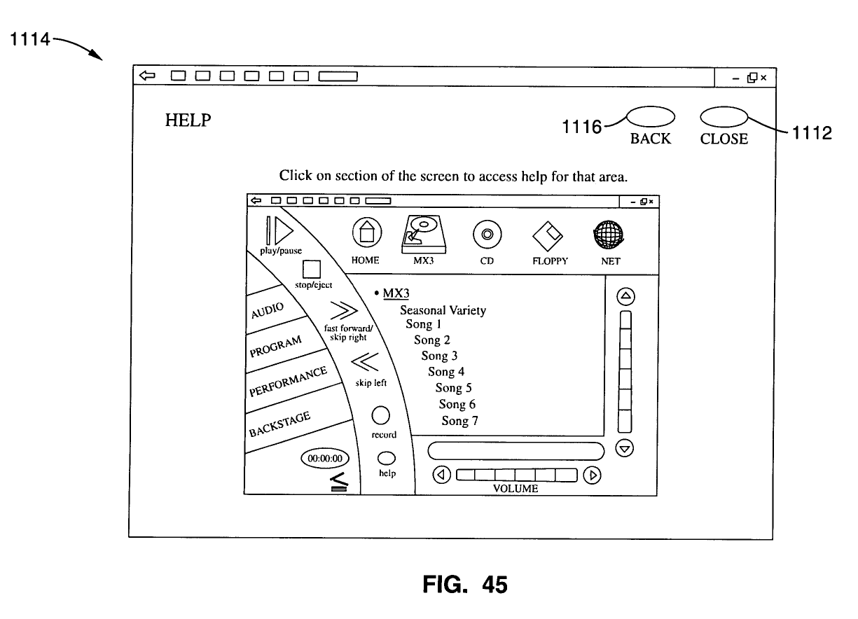

FIG. 45 shows an exemplary, non-limiting main interface help screen 1114 that can be reached by toggling the main interface thumbnail 1102 (FIG. 44). As shown, the main interface help screen 1114 can include a “BACK” button 1116. FIG. 45 also shows the “CLOSE” button 1112 that can be toggled to exit the help interface.

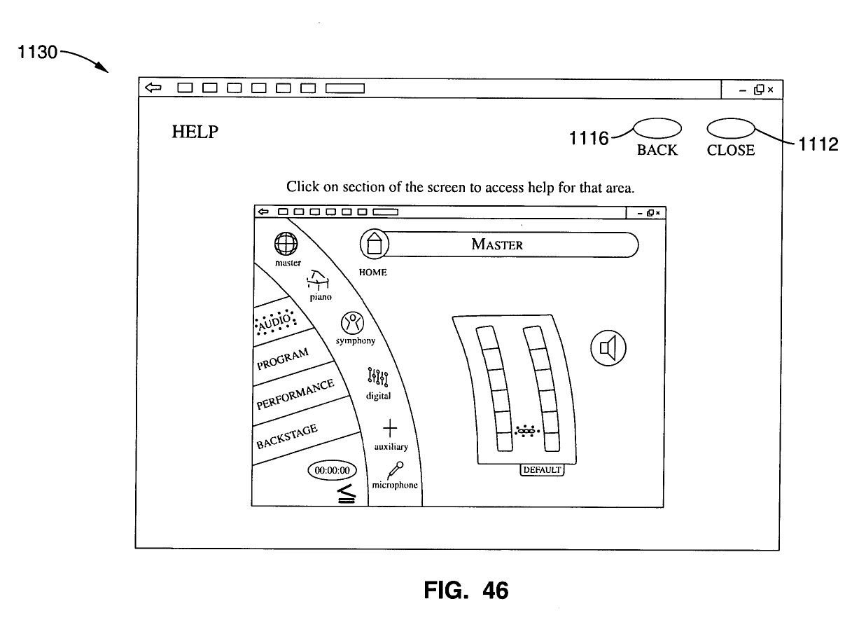

FIG. 46 shows an audio interface help screen, designated 1130 that can be reached by toggling the audio interface thumbnail 1104 (FIG. 44). As shown, the audio interface help screen 1130 can include the “BACK” button 1116 and the “CLOSE” Button 1112.

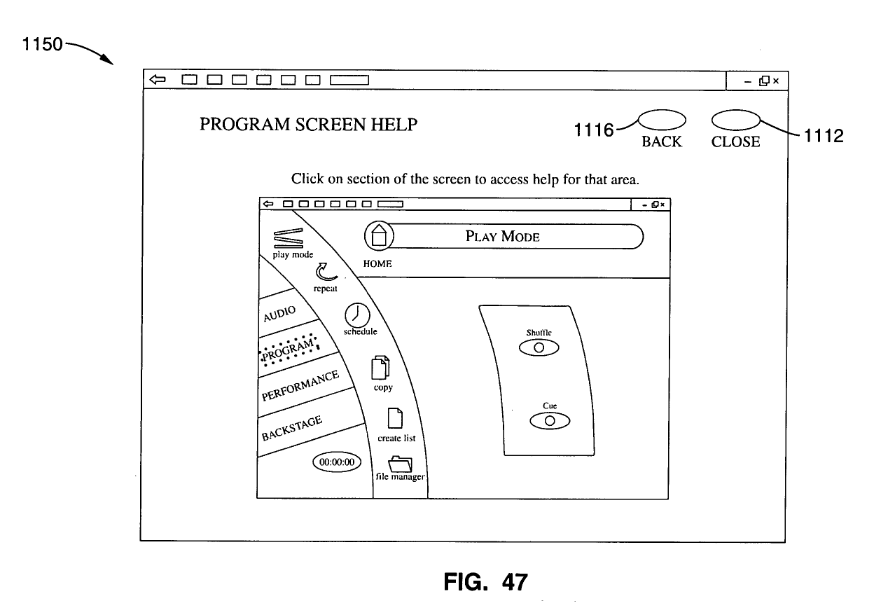

Referring also to FIG. 47, a program interface help screen is shown and is generally designated 1150. The program interface help screen 1150 can be reached by toggling the program interface thumbnail 1106 (FIG. 44). As shown, the program interface help screen 1150 can include the “BACK” button 1116 and the “CLOSE” Button 1112.

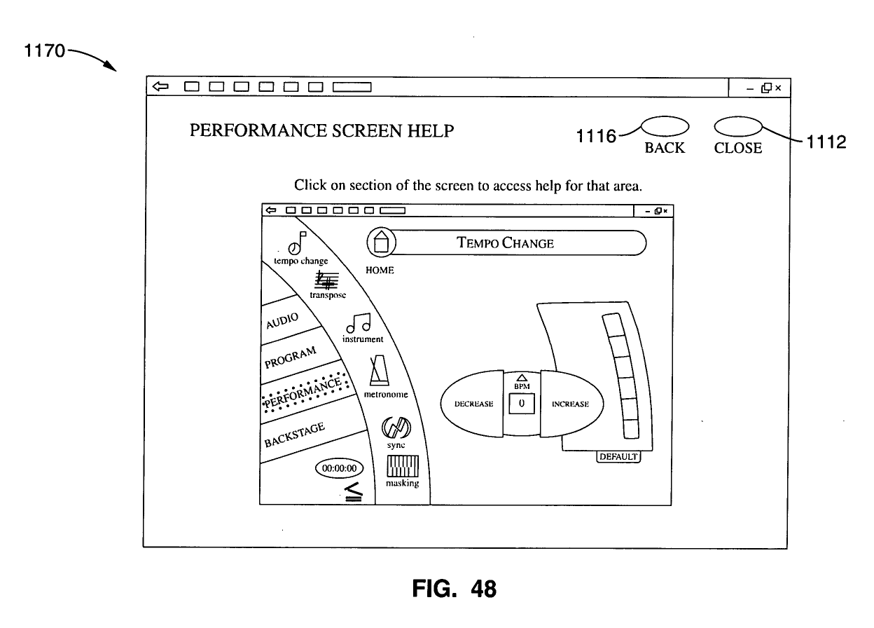

FIG. 48 shows an exemplary, non-limiting performance interface help screen, designated 1170, which can be reached by toggling the performance interface thumbnail 1108 (FIG. 44). As shown, the performance interface help screen 1170 can include the “BACK” button 1116 and the “CLOSE” Button 1112.

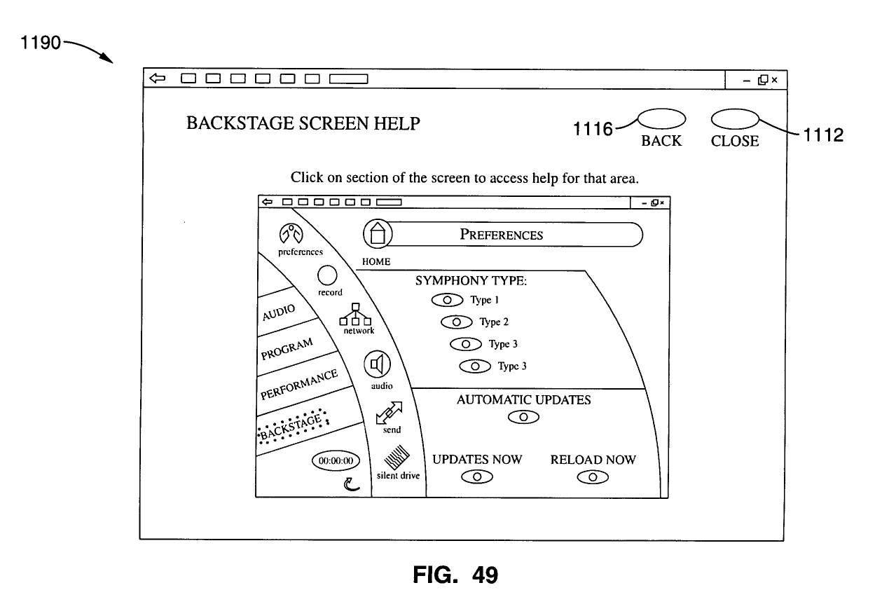

FIG. 49 shows an exemplary, non-limiting backstage interface help screen, designated 1190, that can be reached by toggling the backstage interface thumbnail 1110 (FIG. 43). As shown, the backstage interface help screen 1190 can include the “BACK” button 1116 and the “CLOSE” Button 1112.

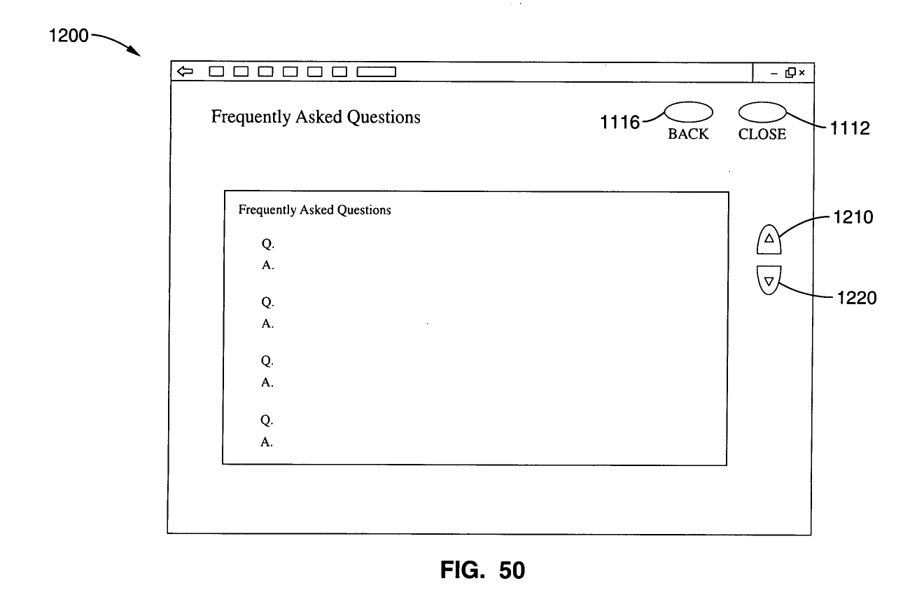

Referring now to FIG. 50, the frequently asked questions screen is shown and is generally designated 1200. The frequently asked questions screen can be reached by toggling the “Or touch here for Frequently Asked Questions” link 1113 (FIG. 44). An up button 1210 and a down button 1220 are also provided and can be used to scroll through the list of questions and answers. As shown, the frequently asked questions screen 1200 can include the “BACK” button 1116 and the “CLOSE” Button 1112.

It is to be understood that in the help screens 1114, 1130, 1150, 1170, 1190, when the user toggles a particular part of the screen, e.g., a button, a text bubble appears on the screen to explain to a user what that particular button can be used to accomplish.

It can be seen that each of the interfaces described in detail above can be presented in various forms on any of the access devices as described in conjunction with FIG. 2, such as PDA 50, the handheld remote control 52, the web slate 54, the TV/Monitor 44, the personal computer 46, and/or the Internet appliance 48. Further, many of the above-described interfaces can be displayed using a browser such as Mozilla. Moreover, many of the advanced features can be accomplished using JAVA, HTML, or Macromedia Flash. Screen resolution of the interfaces can be 640×480 with support for at least 8-bit color. Other configurations can utilize 800×600 resolution with 16-bit color, or any combination of resolutions and colors that the viewing device can handle. In a preferred embodiment, a touch screen is the main input device. Also, many features can be implemented using CGI scripts (Perl and shell scripts).

In a preferred embodiment, a list of songs can be available from the system. The list can include directories of categories that contain additional songs. Within the list, a category or disk title can be displayed. The user can select a song or a directory and the interface can call a CGI script that informs the microprocessor 20 (FIG. 2) what song was selected. If a directory is selected, a new song list can be available from the microprocessor 20 (FIG. 2). If a song is selected, the microprocessor 20 (FIG. 2) can cue the song in preparation for playback. Moreover, if a particular media source, e.g., the hard disk drive 22 (FIG. 2), is unavailable, its icon can appear gray or not appear at all. If the media source is available its icon can appear in full color.

With the configuration of structure described above, a user can remotely access a variety of functions associated with the operation of a player piano. Moreover, a user can program the piano to play with an accompanying instrument or the user can play the piano with the accompanying instrument. A user can also record the music that he or she is playing and store it for playback at a later time.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A player piano interface, comprising:
a core computing device with programming configured for installation within a player piano and operably coupled to key and pedal controls of the player piano;
means for communication between said core computing device and a second computing device;
at least one storage device connected to the core computing device; and
a controller providing access to said core computing device.

2. A player piano interface as recited in claim 1, wherein said core computing device further comprises a display.

3. A player piano interface as recited in claim 1, wherein said core computing device further comprises a plurality of speakers.

4. A player piano interface as recited in claim 1, wherein said core computing device further comprises at least one input device selected from the group of devices consisting essentially of a microphone, a camera, a floppy disk drive, a CD drive, and a DVD drive.

5. A player piano interface as recited in claim 1, wherein said means for communication comprises an Internet connection.

6. A player piano interface as recited in claim 1, wherein said means for communication comprises a telephonic connection.

7. A player piano interface as recited in claim 1, wherein said second computing device is a device selected from the group of devices consisting essentially of: a core computing device of a second player piano; a personal computer; and a music database server.

8. A player piano interface as recited in claim 1, wherein said controller is a wireless device.

9. A player piano interface as recited in claim 8, wherein the controller is a device selected from the group of devices consisting essentially of a portable data assistant remote, a handheld remote, a laptop computer and a web slate.

10. A player piano interface as recited in claim 8, wherein said controller is a wireless device having a touchscreen with a graphical user interface configured to communicate with the core computing device, the wireless device providing access to at least one player piano control.

11. A player piano interface as recited in claim 1, wherein said storage device selected from the group of storage devices consisting essentially of a hard disk drive, a floppy disk drive, a CD Drive, a DVD drive, and an Internet server.

12. A player piano interface as recited in claim 1, wherein said programming of said core computing device provides functional control over the key and pedal controls of a player piano with an audio interface, a program interface, a performance interface and a backstage interface.

13. A player piano interface as recited in claim 12, wherein the audio interface comprises at least one piano volume control, symphony volume control, a digital volume control, an auxiliary device volume control, or microphone volume control.

14. A player piano interface as recited in claim 12, wherein the program control comprises at least one repeat, shuffle, queue, scheduled playback, create playlist, edit playlist, or file management function.

15. A player piano system, comprising:
a player piano;
a core computing device with programming configured for installation within a player piano and operably coupled to key and pedal controls of the player piano;
means for communication between said core computing device and a second computing device;
at least one storage device connected to the core computing device; and
a controller providing access to said core computing device.

16. A player piano system as recited in claim 15, wherein said core computing device further comprises a display.

17. A player piano system as recited in claim 15, wherein said core computing device further comprises a plurality of speakers.

18. A player piano system as recited in claim 15, wherein said core computing device further comprises at least one input device selected from the group of devices consisting essentially of a microphone, a camera, a floppy disk drive, a CD drive, and a DVD drive.

19. A player piano system as recited in claim 15, wherein said means for communication comprises an Internet connection.

20. A player piano system as recited in claim 15, wherein said means for communication comprises a telephonic connection.

21. A player piano system as recited in claim 15, wherein said second computing device is a device selected from the group of devices consisting essentially of: a core computing device of a second player piano, a personal computer, and a music database server.

22. A player piano system as recited in claim 15, wherein said controller is a wireless device.

23. A player piano interface as recited in claim 22, wherein the controller is a device selected from the group of devices consisting essentially of a portable data assistant remote, a handheld remote, a laptop computer and a web slate.

24. A player piano system as recited in claim 22, wherein said controller is a wireless device having a touchscreen with a graphical user interface configured to communicate with the core computing device, the wireless device providing access to at least one player piano control.
